(19) United States
(12) Patent Application Publication
(10) Pub. No.: US 2026/0092488 A1
(43) Pub. Date: Apr. 2, 2026

(54) Automated Motorized Window Treatment System

(71) Applicant: Lutron Technology Company LLC, Coopersburg, PA (US)

(72) Inventor: Brent Protzman, Easton, PA (US)

(73) Assignee: Lutron Technology Company LLC, Coopersburg, PA (US)

(21) Appl. No.: 19/319,065

(22) Filed: Sep. 4, 2025

Related U.S. Application Data
(60) Provisional application No. 63/690,434, filed on Sep. 4, 2024.

(51) Int. Cl. E05F 15/79; E05F 15/603; E06B 9/24; E06B 9/322; E06B 9/40; E06B 9/68; E06B 9/72

(52) U.S. Cl. CPC E05F 15/79; E05F 15/603; E06B 9/322; E06B 9/40; E06B 9/72; E05Y 2400/42; E06B 2009/2417; E06B 2009/6827

(57) ABSTRACT

A method of configuring a shade automation show for controlling a motorized window treatment installed on a façade of a building may be disclosed herein. The method may comprise determining to adjust at least one of a first façade limit angle or a second façade limit angle of a direct-sun range for the façade. The method may further comprise determining an adjustment amount for adjusting the first or second façade limit angle; determining a time direction for adjusting the first or second façade limit angle; and adjusting the first or second façade limit angle based on the determined adjustment amount and the determined time direction. The motorized window treatment may be controlled to a direct-sun state when a solar azimuth angle of the sun is within the first and second façade limit angles direct-sun range.

### CROSS-REFERENCE TO RELATED APPLICATIONS

This application claims benefit of Provisional U.S. Patent Application No. 63/690,434, filed on Sep. 4, 2024, the entire disclosure of which are hereby incorporated by reference herein in their entirety.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and cooling (HVAC) system may be used to control the temperature in the user environment. Each load control system may include various control devices, including control-source devices and control-target devices. The control-target devices may receive messages (e.g., digital messages), which may include load control instructions, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motorized window treatment, a temperature control device (e.g., a thermostat), a plug-in load control device, and/or the like. Examples of control-source devices may include remote control devices, occupancy sensors, daylight sensors, temperature sensors, and/or the like.

### SUMMARY

As described herein, a method of controlling a motorized window treatment installed on a façade of a building may comprise: (1) determining a façade angle of the façade of the building; (2) determining a direct-sun range for the façade of the building based on the façade angle, the direct-sun range extending from a first façade limit angle to a second façade limit angle; (3) determining to adjust at least one of the first façade limit angle or the second façade limit angle; (4) determining an adjustment amount for adjusting the at least one of the first façade limit angle or the second façade limit angle; (5) determining a time direction for adjusting the at least one of the first façade limit angle or the second façade limit angle; (6) adjusting the at least one of the first façade limit angle or the second façade limit angle based on the determined adjustment amount and the determined time direction; and (7) controlling the motorized window treatment to a direct-sun state when a solar azimuth angle of the sun at the building is within the direct-sun range.

In some examples, determining to adjust at least one of the first façade limit angle or the second façade limit angle may further comprise receiving an indication to adjust at least one of the first façade limit angle or the second façade limit angle. For example, receiving an indication to adjust at least one of the first façade limit angle or the second façade limit angle may further comprise receiving an indication of a selection of one of a number of options for adjusting the at least one of the first façade limit angle or the second façade limit angle. In addition, determining an adjustment amount for adjusting the at least one of the first façade limit angle or the second façade limit angle may further comprise determining the adjustment amount in response to the selected one of the number of options for adjusting the at least one of the first façade limit angle or the second façade limit angle. Further, determining a time direction for adjusting the at least one of the first façade limit angle or the second façade limit angle may further comprise determining the time direction in response to the selected one of the number of options for adjusting the at least one of the first façade limit angle or the second façade limit angle.

In addition, a processing device configured to control a motorized window treatment installed on a façade of a building may be described herein. The processing device may comprise a communication circuit configured to transmit messages, and a control circuit configured to determine a façade angle of the façade of the building and determine a direct-sun range for the façade of the building based on the façade angle, the direct-sun range extending from a first façade limit angle to a second façade limit angle. The control circuit may be configured to determine to adjust at least one of the first façade limit angle or the second façade limit angle, determine an adjustment amount for adjusting the at least one of the first façade limit angle or the second façade limit angle, and determine a time direction for adjusting the at least one of the first façade limit angle or the second façade limit angle. The control circuit may be further configured to adjust the at least one of the first façade limit angle or the second façade limit angle based on the determined adjustment amount and the determined time direction, and transmit one or more messages for controlling the motorized window treatment to a direct-sun state when a solar azimuth angle of the sun at the building is within the direct-sun range.

Further, a motorized window treatment configured to be installed on a façade of a building may be described herein. The motorized window treatment may comprise a covering material, and a motor drive unit configured to determine a façade angle of the façade of the building, and determine a direct-sun range for the façade of the building based on the façade angle, the direct-sun range extending from a first façade limit angle to a second façade limit angle. The motor drive unit may be configured to determine to adjust at least one of the first façade limit angle or the second façade limit angle, determine an adjustment amount for adjusting the at least one of the first façade limit angle or the second façade limit angle, and determine a time direction for adjusting the at least one of the first façade limit angle or the second façade limit angle. The motor drive unit may be further configured to adjust the at least one of the first façade limit angle or the second façade limit angle based on the determined adjustment amount and the determined time direction, and control the covering material to a direct-sun state when a solar azimuth angle of the sun at the building is within the direct-sun range.

As further described herein, a method of controlling a motorized window treatment installed on a façade of a building may comprise: (1) determining a façade angle of the façade of the building; (2) determining a direct-sun range for the façade of the building based on the façade angle, the direct-sun range extending from a first façade limit angle to a second façade limit angle; (3) generating a timeclock schedule having at least one event for controlling the motorized window treatment to a direct-sun state, wherein the at last one event defines an event time that is based on at least one of the first façade limit angle or the second façade limit angle; (4) determining an actual time that either direct sunlight started shining on the façade or direct sunlight stopped shining on the façade; (5) comparing the event time of the at least one event and the actual time that either direct sunlight was determined to have started shining on the façade or direct sunlight was determined to have stopped shining on the façade; (6) adjusting the at least one of the first façade limit angle or the second façade limit angle in response to the comparison of the event time and the actual time; and (7) controlling the motorized window treatment to the direct-sun state when a solar azimuth angle of the sun at the building is within the direct-sun range according to the timeclock schedule.

### BRIEF DESCRIPTION OF THE DRAWINGS

FIG. 1 is a diagram of an example load control system.

FIG. 2 is a perspective view of an example motorized window treatment, e.g., a motorized roller shade.

FIG. 3 is a perspective view of another example motorized window treatment, e.g., a motorized blind.

FIG. 4A is a perspective view of an example building in which the motorized window treatments of FIGS. 2 and 3 may be installed.

FIGS. 4B and 4C are top views of the building of FIG. 4A.

FIG. 4D shows an example timeclock schedule (e.g., a shade automation show) that may be used to control the motorized window treatments of the building of FIG. 4A.

FIGS. 5 and 6 illustrate example screens (e.g., graphical user interface windows) that may be used to configure one or more motorized window treatments for operation during a shade automation mode.

FIG. 7 is a simplified block diagram of a motor drive unit of a motorized window treatment (e.g., the motorized window treatments of FIGS. 2 and 3).

FIG. 8 is a block diagram of an example processing device (e.g., which may be used to configure one or more motorized window treatments for operation during a shade automation mode).

FIG. 9 is a flowchart of an example procedure that may be executed to configure one or more timeclock schedule for controlling (e.g., automatically controlling) one or more motorized window treatments.

FIG. 10 is a flowchart of an example procedure that may be executed to configure a timeclock schedule for controlling (e.g., automatically controlling) states (e.g., positions of covering materials and/or tilt angles of slat) of one or more motorized window treatments of a particular shade group and/or on a particular façade of a building

FIG. 11 is a flowchart of an example procedure that may be executed to configure timeclock events of a timeclock schedule for controlling (e.g., automatically controlling) one or more motorized treatments.

FIG. 12 is a flowchart of an example procedure that may be executed to configure a direct-sun range of a shade automation show.

### DETAILED DESCRIPTION

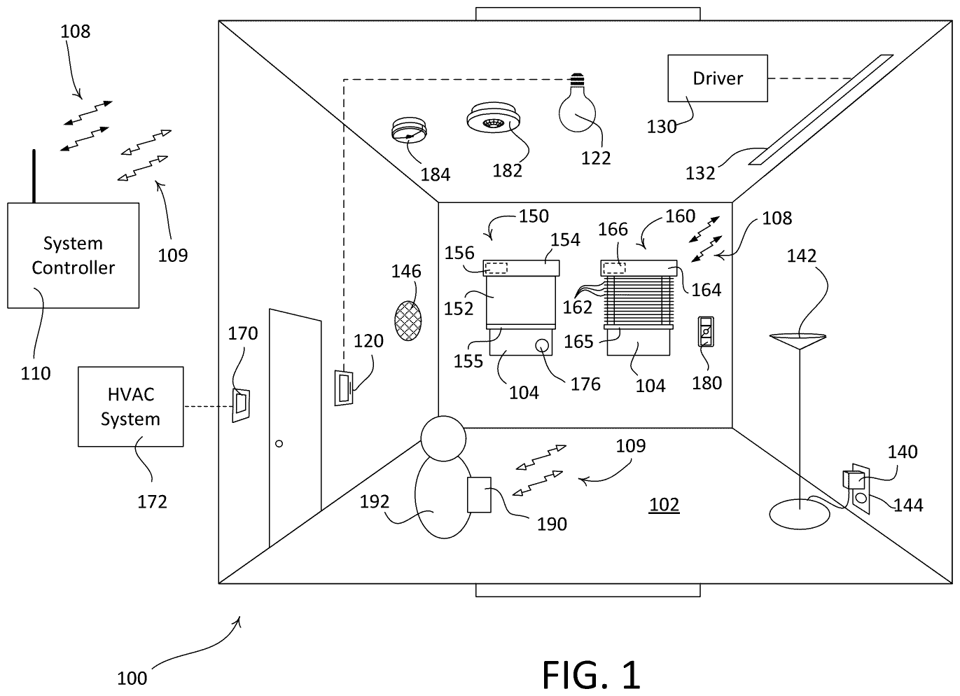

FIG. 1 is a diagram of an example load control system 100 for controlling an amount of power delivered from a power source (not shown), such as an alternating-current (AC) power source or a direct-current (DC) power source, to one or more electrical loads. The load control system 100 may be installed in a room 102 of a building. The load control system 100 may comprise a plurality of control devices configured to communicate with each other by transmitting and receiving messages (e.g., digital messages) via wireless signals, e.g., radio-frequency (RF) signals 108. Alternatively or additionally, the load control system 100 may comprise a wired digital communication link coupled to one or more of the control devices to provide for communication between the control devices. The control devices of the load control system 100 may comprise a number of control-source devices (e.g., input devices operable to transmit messages in response to user inputs, occupancy and/or vacancy conditions, changes in measured light intensity, etc.) and a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) configured to communicate messages to and from the control devices (e.g., the control-source devices and/or the control-target devices). For example, the system controller 110 may be configured to receive messages from the control-source devices and transmit messages to the control-target devices in response to the messages received from the control-source devices.

The load control system 100 may comprise one or more load control devices, such as a dimmer switch 120 (e.g., a control-target device) for controlling a lighting load 122. The dimmer switch 120 may be configured to control an amount of power delivered from the AC power source to the lighting load to adjust an intensity level and/or a color (e.g., a color temperature) of the lighting load. The dimmer switch 120 may be adapted to be wall-mounted in a standard electrical wallbox. The dimmer switch 120 may also comprise a tabletop or plug-in load control device. The dimmer switch 120 may comprise a toggle actuator (e.g., a button) and an intensity adjustment actuator (e.g., a rocker switch). Actuations (e.g., successive actuations) of the toggle actuator may toggle (e.g., turn off and on) the lighting load 122. Actuations of an upper portion or a lower portion of the intensity adjustment actuator may respectively increase or decrease the amount of power delivered to the lighting load 122 and thus increase or decrease the intensity of the receptive lighting load from a minimum intensity (e.g., approximately 1%) to a maximum intensity (e.g., approximately 100%). The dimmer switch 120 may comprise a plurality of visual indicators, e.g., light-emitting diodes (LEDs), which are arranged in a linear array and are illuminated to provide feedback of the intensity of the lighting load 122. Examples of wall-mounted dimmer switches are described in greater detail in U.S. Pat. No. 9,679,696, issue Jun. 13, 2017, entitled WIRELESS LOAD CONTROL DEVICE, the entire disclosure of which is hereby incorporated by reference.

The dimmer switch 120 may be configured to wirelessly receive messages via the RF signals 108 (e.g., from the system controller 110) and to control the lighting load 122 in response to the received messages. Examples of dimmer switches and other control devices configured to transmit and receive messages are described in greater detail in U.S. Pat. No. 10,041,292, issued Aug. 7, 2018, entitled LOW-POWER RADIO-FREQUENCY RECEIVER, and U.S. Pat. No. 10,271,407, issued Apr. 23, 2019, entitled LOAD CONTROL DEVICE HAVING INTERNET CONNECTIVITY, the entire disclosures of which are hereby incorporated by reference.

The load control system 100 may comprise one or more remotely-located load control devices, such as a light-emitting diode (LED) driver 130 (e.g., a control-target device) for driving an LED light source 132 (e.g., an LED light engine). The LED driver 130 may be located remotely, for example, in or adjacent to the lighting fixture of the LED light source 132. The LED driver 130 may be configured to receive messages via the RF signals 108 (e.g., from the system controller 110) and to control the LED light source 132 in response to the received messages. The LED driver 130 may be configured to adjust the color temperature of the LED light source 132 in response to the received messages. The load control system 100 may further comprise other types of remotely-located load control devices, such as, for example, electronic dimming ballasts for driving fluorescent lamps.

The load control system 100 may comprise a plug-in load control device 140 (e.g., a control-target device) for controlling a plug-in electrical load, e.g., a plug-in lighting load (e.g., such as a floor lamp 142 or a table lamp) and/or an appliance (e.g., such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108 (e.g., from the system controller 110) and to turn on and off or adjust the intensity of the floor lamp 142 in response to the received messages. Alternatively or additionally, the load control system 100 may comprise controllable receptacles (e.g., control-target devices) for controlling plug-in electrical loads plugged into the receptacles. The load control system 100 may comprise one or more load control devices or appliances that are able to directly receive the wireless signals 108 from the system controller 110, such as a speaker 146 (e.g., part of an audio/visual or intercom system), which is able to generate audible sounds, such as alarms, music, intercom functionality, etc.

The load control system 100 may comprise one or more daylight control devices, e.g., motorized window treatment 150, 160 (e.g., control-target devices), for controlling the amount of daylight entering the room 102. For example, the motorized window treatment 150 may comprise a motorized roller shade and the motorized window treatment 160 may comprise a motorized blind (e.g., a motorized Venetian blind). In addition, each of the motorized window treatments 150, 160 may also comprise one or more of a Roman shade, a Persian blind, a cellular shade, a pleated blind, a drapery, a tensioned roller shade system, or other suitable motorized window treatment capable of controlling the amount of daylight entering the room 102 through respective windows 104. The motorized window treatments 150, 160 may be battery-powered or may be coupled to an external alternating-current (AC) or direct-current (DC) power source. In addition, the load control system 100 may comprise other types of daylight control devices, such as, for example, an electrochromic or smart window.

The motorized window treatment 150 (e.g., the motorized roller shade) may comprise a covering material, such as a window treatment fabric 152 hanging from a roller tube 154 in front of the respective window 104 with a bottom bar 155 connected to a bottom end of the window treatment fabric 152. The window treatment fabric 152 may be wound around and unwound from the roller tube 154 for respectively raising and lowering the window treatment fabric 152 and the bottom bar 155. The motorized window treatment 150 may further comprise a motor drive unit 156 located inside of the roller tube 154 and having a motor for rotating the roller tube 154 to raise and lower the window treatment fabric 152 for controlling the amount of daylight entering the room 102 through the respective window 104. For example, the motor drive unit 156 may be configured to adjust a present position P_{ROLLER} of the bottom bar 155 (e.g., and the window treatment fabric 152) between a raised position (e.g., a fully-raised position and/or a fully-open position) and a lowered position (e.g., a fully-lowered position and/or a fully-closed position) to control the amount of daylight entering the room 102.

The motorized window treatment 160 (e.g., the motorized blind) may comprise a covering material, such as a plurality of slats 162 disposed between a headrail 164 and a bottom bar 165 (e.g., at a bottom end of the covering material) in front of the respective window 104. The motorized window treatment 160 may further comprise a motor drive unit 166 located inside of the headrail 164 and having a motor for raising and lowering the bottom bar 165 and/or tilting the slats 162 for controlling the amount of daylight entering the room 102 from the respective window 104. For example, the motor drive unit 166 may be configured to adjust a present position P_{BLIND} of the bottom bar 165 (e.g., and the slats 162) between a raised position (e.g., a fully-raised position and/or a fully-open position) and a lowered position (e.g., a fully-lowered position and/or a fully-closed position) to control the amount of daylight entering the room 102. In addition, the motor drive unit 156 may be configured adjust a tilt angle θ_{BLIND} of the slats 162 to control the amount of daylight entering the room 102.

The motor drive units 156, 166 of the respective motorized window treatments 150, 160 may each be configured to communicate (e.g., transmit and/or receive) messages via the RF signals 108. For example, the motor drive units 156, 166 of the respective motorized window treatments 150, 160 may each be configured to receive messages (e.g., from the system controller 110). For example, the motor drive unit 156 of the motorized window treatment 150 may be configured to adjust the present position P_{ROLLER} of the bottom bar 155 in response to the received messages. In addition, the motor drive unit 166 of the motorized window treatment 160 may be configured to adjust the present position P_{BLIND} of the bottom bar 165 and/or the tilt angle θ_{BLIND} of the slats 162 in response to the received messages. In some examples, the motorized window treatments 150, 160 may each comprise a sensor, such as a photosensor (e.g., on the motor drive units 156, 166 and/or on the headrail 164). For example, the photosensor may be configured to measure a light intensity outside of the building in which the load control system 100 is installed.

The motor drive units 156, 166 of each of the motorized window treatments 150, 160 may each comprise one or more energy storage elements (not shown) configured to power the respective motor. The one or more energy storage elements of the respective motor drive units 156, 166 may comprise, for example, one or more of batteries (e.g., rechargeable batteries) and/or supercapacitors. The motor drive units 156, 166 may each be configured to drive the respective motor from a storage voltage produced across the one or more energy storage elements in the respective motor drive unit 156, 166. In some examples, the motor drive unit 156, 166 of each of the motorized window treatments 150, 160 may be coupled to an external alternating-current (AC) or direct-current (DC) power source.

In addition, each of the motorized window treatments 150, 160 may comprise an energy-harvesting power source, such as one or more solar cells (e.g., photovoltaic cells), for powering the respective motor drive unit 156, 166. In some examples, the solar cells may be located on the bottom bars 155, 165 of the motorized window treatments 150, 160, e.g., on rear surfaces (not shown) of the bottom bars 155, 165, such that the solar cells may face the windows 104 and may be able to receive solar energy from outside the building (e.g., from the sun). The bottom bars 155, 165 may each comprise one or more energy storage elements (not shown) configured to charge from the solar cells. The one or more energy storage elements of the respective bottom bars 155, 165 may comprise, for example, one or more of batteries (e.g., rechargeable batteries) and/or supercapacitors. The solar cells of each of the bottom bars 155, 165 may be configured to convert the received solar energy into a photovoltaic output voltage, which may be used to charge the one or more energy storage elements located in the respective bottom bar 155, 165 (e.g., to generate a storage voltage across the one or more energy storage elements).

The motor drive units 156, 158 may each be configured to control the respective bottom bar 155, 165 to the raised position to allow the one or more energy storage elements of the respective bottom bar 155, 165 to discharge into the one or more energy storage elements of the respective motor drive unit 156, 166 for producing the storage voltage across the one or more energy storage elements. For example, the motorized window treatments 150, 160 (e.g., the respective motor drive units 156, 166) may each comprise a dock that may be configured to facilitate discharging of the one or more energy storage elements of the respective bottom bar 155, 165 into the one or more energy storage elements of the respective motor drive unit 156, for example, when the respective bottom bar 155, 165 is in the raised position (e.g., when the respective bottom bar 155, 165 is docked). The dock of each of the motorized window treatments 150, 160 may comprise electrical contacts (not shown) configured to contact respective electrical contacts (not shown) of the respective bottom bar 155, 165 to provide for charging of the one or more energy storage elements of the respective motor drive unit 156, 166 from the one or more energy storage elements of the respective bottom bar 155, 165 when the bottom bar 155, 165 is in the raised position (e.g., when the respective bottom bar 155, 165 is docked). In addition, the motorized window treatments 150, 160 may each be configured to determine (e.g., estimate) the light intensity outside of the building in response to the solar cells on the respective bottom bars 155, 165.

The load control system 100 may comprise one or more temperature control devices, e.g., a thermostat 170 (e.g., a control-target device) for controlling a room temperature in the room 102. The thermostat 170 may be coupled to a heating, ventilation, and air conditioning (HVAC) system 172 via a control link (e.g., an analog control link or a wired digital communication link). The thermostat 170 may be configured to wirelessly communicate messages with a controller of the HVAC system 172. The thermostat 170 may comprise a temperature sensor for measuring the room temperature of the room 102 and may control the HVAC system 172 to adjust the temperature in the room to a setpoint temperature. The load control system 100 may comprise one or more wireless temperature sensors (not shown) located in the room 102 for measuring the room temperatures. For example, the thermostat 170 and the wireless temperature sensors may be battery-powered. The HVAC system 172 may be configured to turn a compressor on and off for cooling the room 102 and to turn a heating source on and off for heating the rooms in response to the control signals received from the thermostat 170. The HVAC system 172 may be configured to turn a fan of the HVAC system on and off in response to the control signals received from the thermostat 170. The thermostat 170 and/or the HVAC system 172 may be configured to control one or more controllable dampers to control the air flow in the room 102.

The load control system 100 may comprise one or more input devices (e.g., control-source devices), such as a remote control device 180, an occupancy sensor 182, a daylight sensor 184, and/or a window sensor 186. The input devices may be fixed or movable input devices. The remote control device 180, the occupancy sensor 182, the daylight sensor 184, and/or the window sensor 186 may be wireless control devices (e.g., RF transmitters) configured to transmit messages via the RF signals 108 to the system controller 110 (e.g., directly to the system controller). The system controller 110 may be configured to transmit one or more messages to the load control devices (e.g., the dimmer switch 120, the LED driver 130, the plug-in load control device 140, the motorized window treatments 150, 160, and/or the thermostat 170) in response to the messages received from the remote control device 180, the occupancy sensor 182, the daylight sensor 184, and/or the window sensor 186. The remote control device 180, the occupancy sensor 182, the daylight sensor 184, and/or the window sensor 186 may also and/or alternatively be configured to transmit messages directly to the dimmer switch 120, the LED driver 130, the plug-in load control device 140, the motorized window treatments 150, 160, and the thermostat 170. For example, the remote control device 180, the occupancy sensor 182, the daylight sensor 184, and/or the window sensor 186 may each be battery-powered.

The remote control device 180 may be configured to transmit messages to the system controller 110 and/or a control-target device via the RF signals 108 in response to an actuation of one or more buttons of the remote control device. Examples of remote control devices are described in greater detail in U.S. Pat. No. 9,361,790, issued Jun. 7, 2016, entitled Remote control for a wireless load control system, and U.S. Pat. No. 9,633,557, issued Apr. 25, 2017, entitled BATTERY-POWERED RETROFIT REMOTE CONTROL DEVICE, the entire disclosures of which are hereby incorporated by reference.

The occupancy sensor 182 may be configured to detect occupancy and/or vacancy conditions in the room 102 (e.g., the room in which the occupancy sensors are mounted). The occupancy sensor 182 may transmit digital messages to the system controller 110 and/or one or more of the load control devices (e.g., the dimmer switch 120, the LED driver 130, the motorized window treatments 150, 160, and/or the thermostat 170) via the RF signals 108 in response to detecting the occupancy or vacancy conditions. For example, the system controller 110 may be configured to control one or more of the load control devices in response to receiving a message including an indication of an occupied condition and/or a vacancy condition from the occupancy sensor 182. In addition, the load control devices may be responsive to a message including an indication of an occupied condition and/or a vacancy condition received directly from the occupancy sensor 182.

The daylight sensor 184 may be configured to measure a light intensity in the room 102 (e.g., the room in which the daylight sensor is installed). The daylight sensor 184 may transmit digital messages (e.g., including the measured light intensity from in the room 102) to the system controller 110 and/or one or more of the load control devices (e.g., the dimmer switch 120, the LED driver 130) via the RF signals 108 for controlling the intensities of the lighting load 122 and/or the LED light source 132 in response to the measured light intensity in the room 102. For example, the system controller 110 may be configured to control the load control devices in response to receiving a message including the measured light intensity in the room 102 from the daylight sensor 184. In addition, the load control devices may be responsive to a message including the measured light intensity in the room 102 received directly from the daylight sensor 184.

The window sensor 186 may be configured to detect and/or measure one or more environmental characteristics outside of the building in which the load control system 100 is installed. For example, the window sensor 186 may be mounted to one of the window 104, and may be configured to measure the light intensity outside of the building. In addition, the window sensor 186 may be configured to detect a glare condition outside of the building. The window sensor 186 may transmit digital messages (e.g., including the measured light intensity from outside of the building and/or an indication of a detected glare condition) to the system controller 110 and/or one or more of the load control devices (e.g., the dimmer switch 120, the LED driver 130) via the RF signals 108 in response for controlling the intensities of the lighting load 122 and/or the LED light source 132 in response to the measured light intensity outside of the building and/or the detected glare condition. The system controller 110 may be configured to control load control devices in response to receiving the measured light intensity outside of the building and/or an indication of the detected glare condition from the window sensor 186. In addition, the load control devices may be responsive to a message including the measured light intensity outside of the building and/or an indication of the detected glare condition received directly from the occupancy sensor 182.

The system controller 110 may be configured to be coupled to a network, such as a wireless or wired local area network (LAN), e.g., for access to the Internet. The system controller 110 may be wirelessly connected to the network. The system controller 110 may be coupled to the network via a network communication bus (e.g., an Ethernet communication link). The system controller 110 may be configured to communicate via the network with one or more network devices, e.g., a stationary computing device (e.g., a computer) and/or a mobile device 190, such as, a personal computing device and/or a wearable wireless device. The mobile device 190 may be located on a user 192, for example, may be attached to the occupant's body or clothing, or may be held by the occupant. The mobile device 190 may be characterized by a unique identifier (e.g., a serial number or address stored in memory) that uniquely identifies the mobile device 190 and thus the user 192. Examples of personal computing devices may include a smart phone, a laptop, and/or a tablet device. Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.).

The mobile device 190 may be configured to transmit digital messages via RF signals 109 to the system controller 110 and/or the load control devices, for example, in one or more Internet Protocol packets. For example, the mobile device 190 may be configured to transmit digital messages to the system controller 110 over the LAN and/or via the Internet. The mobile device 190 may be configured to transmit digital messages over the internet to an external service, and then the digital messages may be received by the system controller 110. The load control system 100 may comprise other types of network devices coupled to the network, such as a desktop personal computer (PC), a wireless-communication-capable television, or any other suitable Internet-Protocol-enabled device.

The operation of the load control system 100 may be programmed and configured using, for example, the mobile device 190 or other network device (e.g., when the mobile device is a personal computing device). The mobile device 190 may execute a design configuration application (e.g., a design configuration software) for allowing the user 192 to program how the load control system 100 will operate. For example, the design configuration software may run as a PC application or a web application with a web-based interface. The configuration software and/or the system controller 110 (e.g., via instructions from the configuration software) may generate system configuration data (e.g., a system configuration database) that defines the operation of the load control system 100. For example, the system configuration data may include information regarding the operational settings of different load control devices of the load control system (e.g., the dimmer switch 120, the LED driver 130, the plug-in load control device 140, the motorized window treatments 150, 160, and/or the thermostat 170). The system configuration data may comprise information regarding associations between the load control devices and the input devices (e.g., the remote control device 180, the occupancy sensor 182, and/or the daylight sensor 184). The system configuration data may comprise information regarding how the load control devices respond to inputs received from the input devices. The design configuration software may display a graphical user interface (GUI) on a visible display of the mobile device 190 for displaying configuration options and/or receiving the inputs from the user 192 to generate the system configuration data. Examples of configuration procedures for load control systems are described in greater detail in U.S. Pat. No. 10,027,127, issued Jul. 17, 2018, entitled COMMISSIONING LOAD CONTROL SYSTEMS, the entire disclosure of which is hereby incorporated by reference.

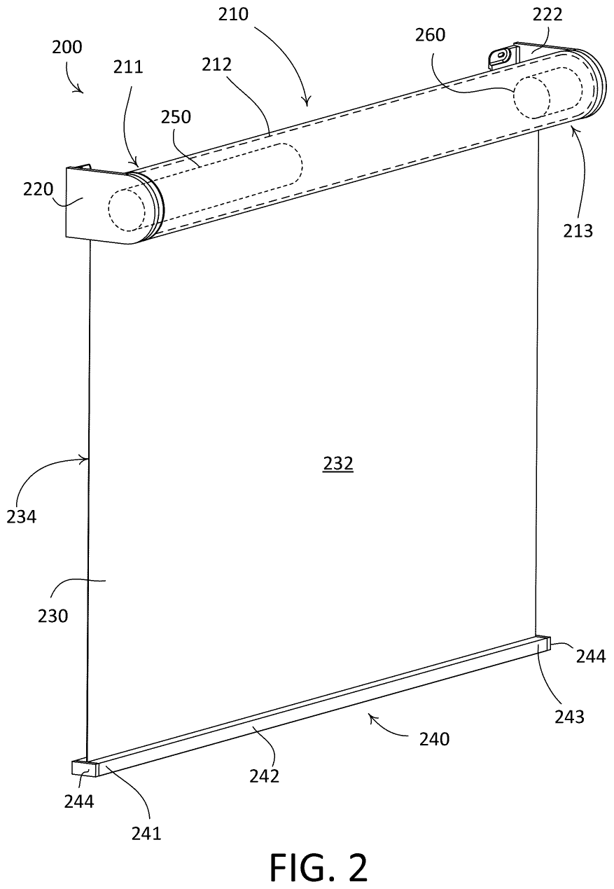

FIG. 2 is a front perspective view of an example motorized window treatment 200 (e.g., a motorized roller shade), which may be deployed as the motorized window treatment 150 of the load control system 100. The motorized window treatment 200 may comprise a window treatment assembly 210 and one or more mounting brackets, such as first and second mounting brackets 220, 222. The first and second mounting brackets 220, 222 may be configured to be coupled to or otherwise mounted to a structure. For example, each of the first and second mounting brackets 220, 222 may be configured to be mounted to (e.g., attached to) a window frame, a wall, or other structure of a building, such that the motorized window treatment 200 may be mounted proximate to an opening (e.g., over the opening or in the opening), such as a window for example. The first and second mounting brackets 220, 222 may be configured to be mounted to a vertical structure (e.g., wall mounted to a wall) and/or mounted to a horizontal structure (e.g., ceiling mounted to a ceiling). The window treatment assembly 210 may be coupled to (e.g., supported by) the first and second mounting bracket 220, 222.

The window treatment assembly 210 may include a roller tube 212, a covering material 230 (e.g., a flexible material), a bottom bar 240 (e.g., a hembar), a motor drive unit 250 at a first end 211 of the roller tube 212, and an idler 260 at a second end 213 of the roller tube 212. The motor drive unit 250 may be coupled to (e.g., fixedly coupled to) the first mounting bracket 220 and be rotatably coupled to the roller tube 212 at the first end 211 of the roller tube 212. The idler 260 may be coupled to (e.g., fixedly coupled to) the second mounting bracket 222 and rotatably coupled to the roller tube 212 at the second end 213 of the roller tube 212. Other configurations of the motor drive unit 250 and the idler 260 are possible. For example, the motor drive unit 250 may be located at the second end 213 of the roller tube 212 and the idler 260 may be located at the first end 211 of the roller tube 212.

The covering material 230 may be windingly attached to the roller tube 212. The covering material 230 may be any suitable material, or form any combination of materials. For example, the covering material 230 may be scrim fabric, woven cloth, non-woven material, light-control film, screen, and/or mesh. The covering material 230 may comprise a top end (not shown) attached to the roller tube 212 and a bottom end (not shown) attached to the bottom bar 240. The bottom bar 240 may comprise a housing 242 having first and second ends 241, 243. In some examples, the bottom end of the covering material 230 may be received within the housing 242 and secured to the bottom bar 240 inside the housing 242. The bottom bar 240 may also comprise, for example, end caps 244 connected to the first and second ends 241, 243 of the bottom bar 240. In addition, the bottom bar 240 (e.g., the housing 242) may be configured, for example weighted, to cause the covering material 230 to hang vertically. For example, the covering material 230 may be configured to cover the window that is proximate to the motorized window treatment 200. The covering material 230 may comprise a front surface 232 that faces the space in which the motorized window treatment 200 is mounted and a rear surface 234 that faces the window.

The roller tube 212 of the window treatment assembly 210 may operate as a rotational element of the motorized window treatment 200. The roller tube 212 of the window treatment assembly 210 may be rotatably mounted to (e.g., rotatably supported by) the first and second mounting brackets 220, 222. The first and second mounting brackets 220, 222 may extend from the structure to which the motorized window treatment 200 is mounted. The covering material 230 may be windingly attached to the roller tube 212, such that rotation of the roller tube 212 causes the covering material 230 to wind around or unwind from the roller tube 212. For example, rotation of the roller tube 212 may cause the covering material 230 (e.g., the bottom bar 240) to move so as to adjust a present position P_{ROLLER} of the bottom bar 240 between a raised position P_{RAISED} and a lowered position P_{LOWERED} (e.g., a fully lowered position and/or a fully-closed position as shown in FIG. 2).

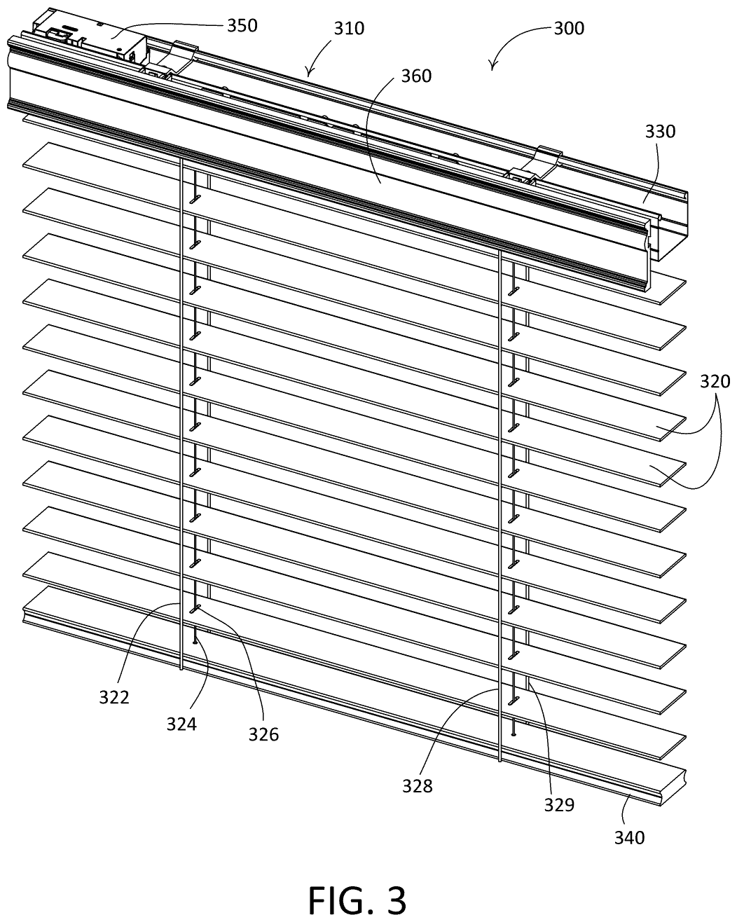

FIG. 3 is a perspective view of an example motorized window treatment 300 (e.g., a motorized Venetian blind), which may be deployed as the motorized window treatments 160 of the load control system 100. The motorized window treatment 300 may comprise a window treatment assembly 310 and one or more mounting brackets (not shown). The mounting brackets may be configured to be mounted to (e.g., attached to) a window frame, a wall, or other structure of a building, such that the motorized window treatment 300 may be mounted proximate to an opening (e.g., over the opening or in the opening), such as a window for example. The mounting brackets may be configured to be mounted to a vertical structure (e.g., wall mounted to a wall) and/or mounted to a horizontal structure (e.g., ceiling mounted to a ceiling). The window treatment assembly 310 may be coupled to (e.g., supported by) the mounting brackets.

The window treatment assembly 310 (e.g., the motorized window treatment 300) may include a covering material, e.g., a plurality of slats 320 (e.g., flat or curved slats), a headrail 330, and a bottom bar 340 (e.g., a bottom rail). The plurality of slats 320 may be disposed between the headrail 330 and the bottom bar 340. The window treatment assembly 310 may comprise tilt ladders 322 (e.g., two tilt ladders) that extend from the headrail 330 to the bottom bar 340 for supporting the slats 320 and lift cords 324 (e.g., two lift cords) that extend from the headrail 330 to the bottom bar 340 (e.g., through openings 326 in the slats 320) for supporting the bottom bar 340. The window treatment assembly 310 may also comprise a motor drive unit 350 located in the headrail 330. The motor drive unit 350 may be operatively coupled to the tilt ladders 322 for tilting the slats 320 and/or to the lift cords 324 for raising and lowering the bottom bar 340. The window treatment assembly 310 may also comprise a valance 360 located in front of the headrail 330.

The motor drive unit 350 may be configured to adjust the covering material of the window treatment assembly 310 to control the amount of daylight entering a space. For example, the motor drive unit 350 may comprise a motor (not shown) configured to be operated to control the amount of daylight entering the space. For example, the motor drive unit 350 may be configured to control the motor to control a position P_{BLIND} of the bottom bar 340 and/or a tilt angle θ_{BLIND} of the slats 320, so as to control the amount of daylight entering the space in which the motorized window treatment 300 is installed. For example, the motor drive unit 350 may control the position P_{BLIND} of the bottom bar 340 between a raised position P_{RAISED} and a lowered position P_{LOWERED} (e.g., a fully lowered position and/or a fully-closed position as shown in FIG. 3). In one example, the motor drive unit 350 may comprise a first motor for raising and lowering the bottom bar 340 and a second motor for tilting the slats 320, such that the motor drive unit 350 may independently control the position of the bottom bar 340 and the tilt angle of the slats 320. In other embodiments, the motor drive unit 350 may be configured to only control one or the other of the position of the bottom bar 340 or the tilt angle of the slats 320 (e.g., the motor drive unit 350 may comprise a single motor). For example, in some examples, the motor drive unit 350 may be configured to only control the tilt angle of the slats 320. In such examples, the position of the bottom bar 340 may be adjustable manually by a user.

The tilt ladders 322 may each have a front band 328 (e.g., a front ribbon) and a rear band 329 (e.g., a rear ribbon) that extend parallel to each other from the headrail 330 to the bottom bar 340 adjacent to the lift cords 324. The front band 328 of the tilt ladders 322 may typically be aligned with (e.g., positioned in front of) the lift cords 324. Each tilt ladder 322 may also comprise a plurality of rungs (not shown) (e.g., bands or ribbons) that extend from the front band 328 to the rear band 329 between each pair of adjacent slats 320 of the window treatment assembly 310 to thus form a ladder. Accordingly, each of the slats 320 may rest on one of the rungs in each of the tilt ladders 322, such that the slats may be equally spaced apart vertically when the bottom bar 340 is in the lowered position P_{LOWERED}. In examples in which the tilt angle of the slats 320 is controlled by the motor drive unit 340, the front and rear bands 328, 329 may be operatively coupled to the motor drive unit 350 in the headrail 330. The motor drive unit 350 may be configured to tilt the slats 320 by vertically moving the front and rear bands 326, 328 with respect to each other, such that the rungs, and thus the slats 320, are tilted at an angle with respect to the front and rear bands 328, 329 (e.g., the tilt angle θ_{BLIND}). Alternatively, the front and rear bands 328, 329 and the rungs of the tilt ladders 322 could comprise cords. In examples that include the motor drive unit 350 raising and lowering the bottom bar 340, the motor drive unit 350 may be configured to wind and unwind the lift cords 324 to respectively raise and lower the covering material 320 (e.g., the bottom bar 340) to control a position P_{BLIND} of the covering material 320 between the raised position P_{RAISED} and the lowered position P_{LOWERED}. In such examples, as the motor drive unit 350 winds up the lift cords 324 to raise the bottom bar 340, the slats 320 may each contact the bottom bar 340 one-by-one and may be raised up with the bottom bar 340. As the motor drive unit 350 raises the bottom bar 340, the portions of the tilt ladders 322 between adjacent rungs may become slack as the raising bottom bar 340 and accumulating slats 320 meet the next slat.

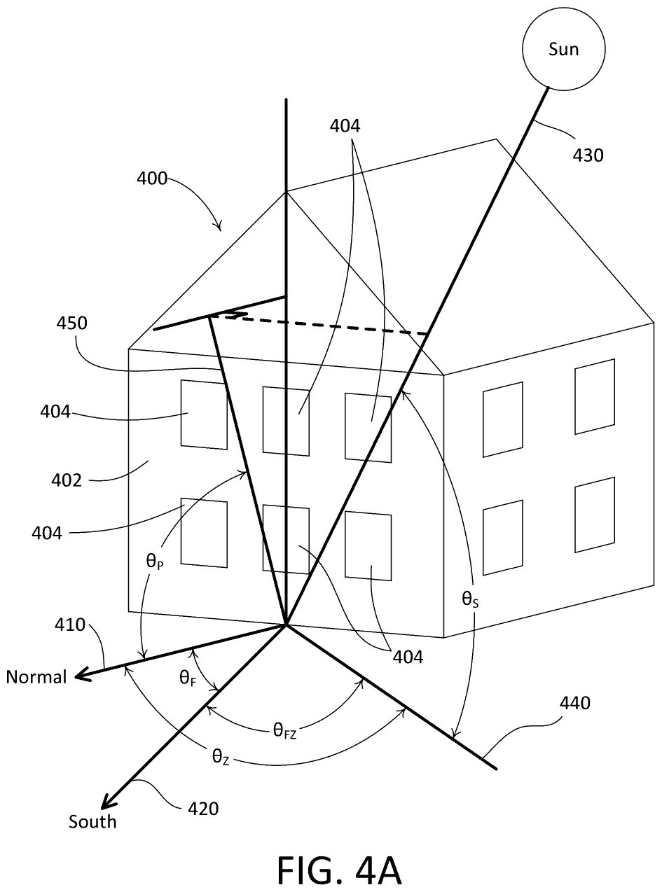

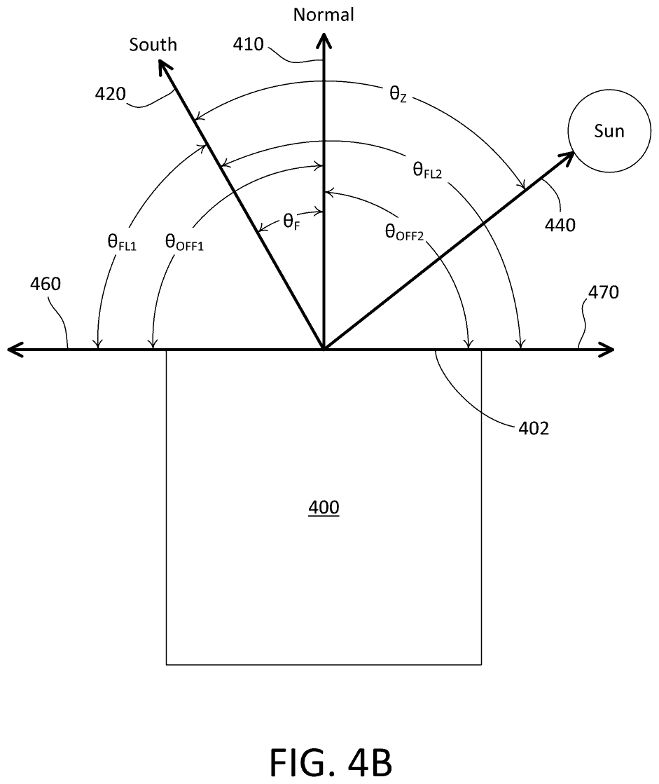

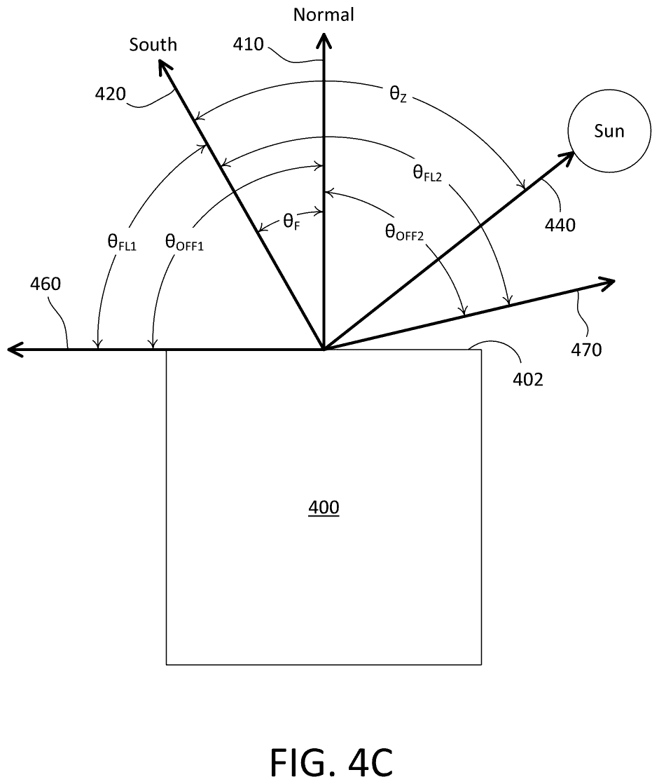

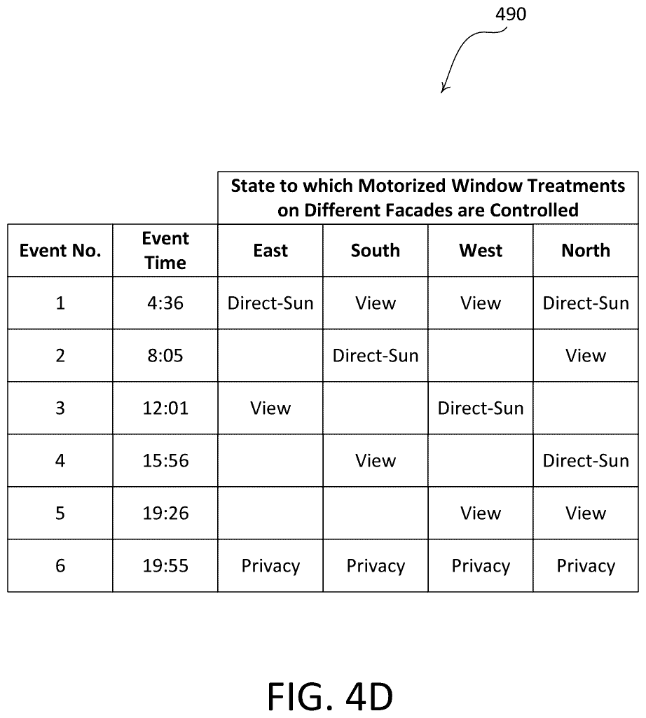

FIG. 4A is a perspective view of an example building 400 having a façade 402 that includes windows 404. The building 400 may have a load control system (e.g., the load control system 100) installed therein. The load control system may comprise one or more motorized window treatments (e.g., the motorized window treatments 150, 160) mounted inside the building 400 so as to cover one or more of the windows 404. For example, the motorized window treatments may comprise one or more motorized roller shades (e.g., such as the motorized window treatment 150 of FIG. 1 and/or the motorized window treatment 200 of FIG. 2) and/or one or more motorized blinds (e.g., such as the motorized window treatment 160 of FIG. 1 and/or the motorized window treatment 300 of FIG. 3). Other example motorized window treatments may be used.

The load control system installed in the building 400 may comprise a system controller (e.g., such as the system controller 110) for controlling (e.g., automatically controlling) the motorized window treatments to control the amount of daylight entering the windows 404 of the façade 402. When the motorized window treatments are motorized roller shades, the system controller may be configured to control each of the motorized roller shades to adjust a position P_{ROLLER} of a bottom bar of the motorized roller shades (e.g., the bottom bar 240). When the motorized window treatments are motorized blinds, the system controller may be configured to control each of the motorized blinds to adjust a tilt angle θ_{BLIND} of slats (e.g., the slats 320) to a view angle θ_{VIEW}. For example, when operating in a shade automation mode, the system controller may be configured to control (e.g., automatically control) the motorized window treatments to minimize (e.g., prevent) glare conditions, to provide view through the windows 400, and/or provide privacy. The system controller may be configured to control the motorized window treatments in response to a position of the sun with respect to the building 400, for example, to determine if the sun is positioned to shine directly on the façade 402 of the building 400 (e.g., if direct sunlight may be incident on the façade 402).

In response to the determined position of the sun, the system controller may be configured to control (e.g., automatically control) the motorized window treatments to one or three states, e.g., a view state, a direct-sun state, and a privacy state. The system controller may be configured to control the motorized window treatments to the privacy state during a night-time period, which may extend between times relative to sunrise and sunset times for the present day. For example, the night-time period may start at a sunset time t_{SUNSET} and end at a sunrise time t_{SUNRISE} for the present day. In addition, the night-time period may start at a first time that is offset from the sunset time t_{SUNSET} and end at a second time that is offset from the sunrise time t_{SUNRISE}. When in the privacy state, each of the motorized window treatments may be controlled to provide privacy to occupants inside of the building 400 (e.g., to prevent view through the windows 404 of the building 400). For example, the motorized roller shades may adjust the position P_{ROLLER} of the bottom bar to a privacy position P_{PRIVACY} (e.g., a fully-lowered position) and/or the motorized blinds may adjust the tilt angle θ_{BLIND} of the slats to a privacy angle θ_{PRIVACY} (e.g., which may orient the slats substantially vertically, such as approximately 90° from the horizontal plane).

Outside of the night time period, the system controller may be configured to control the motorized window treatments to the view state when the system controller determines that the sun is not positioned to shine directly on the façade 402 of the building 400 and to the direct-sun state when the system controller determines that the sun is positioned to shine directly on the façade 402 of the building 400. When in the view state, each of the motorized window treatments may be controlled to allow indirect sunlight to shine into the interior of the building 400 and/or to provide view through the windows 400. For example, the motorized roller shades may adjust the position P_{ROLLER} of the bottom bar to a view position P_{VIEW} (e.g., a fully-raised position or a visor position) and/or the motorized blinds may adjust the tilt angle θ_{BLIND} of the slats to a view angle θ_{VIEW} (e.g., which may orient the slats substantially horizontally, such as approximately 0° from the horizontal plane). When in the direct-sun state, each of the motorized window treatments may be controlled to minimize (e.g., prevent) direct sunlight from shining into the interior of the building 400, but allow some indirect sunlight to shine into the interior of the building 400. For example, the motorized roller shades may adjust the position P_{ROLLER} of the bottom bar to a direct-sun position P_{D-SUN} (e.g., an intermediate position between the fully-raised position and the fully-lowered position) and/or the motorized blinds may adjust the tilt angle θ_{BLIND} of the slats to a direct-sun angle θ_{D-SUN} (e.g., an angle between the view angle θ_{VIEW} and the privacy angle θ_{PRIVACY}). For example, the direct-sun angle θ_{D-SUN} may be approximately 45° from the horizontal plane or 50% between the privacy angle θ_{PRIVACY} and the view angle θ_{VIEW}, such that the slats are approximately normal to the direction of the sun, although it will be appreciated that the direct-sun angle θ_{D-SUN} may vary between 0° and 90°, such as, for example, 30°, 45°, 60°, etc.

When operating in the shade automation mode, each of the motorized window treatments may be controlled (e.g., automatically controlled) according to a predetermined timeclock schedule. The system controller may be configured to generate a timeclock schedule (e.g., an individual timeclock schedule) for each of the motorized window treatments that is operating in the shade automation mode. The system controller may be configured to generate a new timeclock schedule for each of the motorized window treatments on a daily basis (e.g., during the night-time period while the motorized window treatments are in the privacy state prior to the day of the timeclock schedule). The system controller may be configured to store the timeclock schedule and transmit commands to control each of the motorized window treatments that are operating in the shade automation mode to one of the view, direct-sun, and privacy states according to the timeclock schedule. In addition, the system controller may transmit the timeclock schedule to each of the motorized window treatments that are operating in the shade automation mode for use during the coming day. Each of the motorized window treatments that are operating in the shade automation mode may each be configured to store the timeclock schedule in memory (e.g., a new timeclock schedule each day) and adjust to the view, direct-sun, and/or privacy states at respective event times of the timeclock schedule during the day (e.g., each of the motorized window treatments may be configured to execute a timeclock). Further, each of the motorized window treatments that are operating in the shade automation mode may be configured to generate the respective timeclock schedule each day itself. Additionally and/or alternatively, the system controller and/or each of the motorized window treatments that are operating in the shade automation mode may be configured to generate timeclock schedules for multiple upcoming days, store the timeclock schedules in the memory, and/or transmit the timeclock schedules.

In order to determine when and how to generate the timeclock events of the timeclock schedule for a day, the system controller and/or the motorized window treatments may be configured to calculate a predicted position of the sun at a plurality of discrete times in the day. The system controller and/or the motorized window treatments may determine the position of the sun relative to the façade 402 on which the windows 404 are located. The façade 402 may be directed in a particular direction relative to the cardinal directions (e.g., on a compass). As shown in FIG. 4A, the façade 402 may be characterized by a line 410 that is normal (e.g., perpendicular) to the façade 402. The line 410 that is normal to the façade 402 may be spaced from a line 420 directed south (e.g., due south) by a façade angle θ_{F}. The position of the sun in the sky may be defined by a solar altitude angle θ_{S} and a solar azimuth angle θ_{Z}. As shown in FIG. 4A, the solar altitude angle θ_{S} may be the angle between a line 430 directed from the façade 402 towards the sun and a line 440 directed from the façade 402 towards the sun projected on the ground (e.g., a line directed towards the horizon at the position of the building 400). The solar altitude angle θ_{S} may also be thought of as the angle of incidence of the sun's rays on a horizontal surface. The solar azimuth angle θ_{Z} may be the angle between by the line 420 that is directed south from the façade 402 and the line 440 directed towards the sun from the façade 402 projected on the ground.

The system controller and/or the motorized window treatments may be configured to calculate the solar altitude angle θ_{S} and the solar azimuth angle θ_{Z} as functions of the date (e.g., a Julian date) and time (e.g., a standard time tₛ), as well as the geographic position (e.g., longitude λ and latitude Φ) of the building 400 in which the motorized window treatments are located. For example, the system controller and/or the motorized window treatments may be configured to calculate the solar altitude angle θ_{S} and the solar azimuth angle θ_{Z} using the following equations. The difference in a solar time tₛₒₗₐᵣ (e.g., a time as given by a sundial) and the standard time tₛ (e.g., a time as given by a clock) due to the obliquity of the Earth's axis of rotation may be defined by an equation of time ET. The equation of time ET can be determined as a function of the present Julian date J using, for example, the equation:

$$ET = 0.1644 \cdot sin ( A ) - 0.1273 \cdot cos ( B ) , \qquad ( Equation 1 )$$

where A=[4π·(J−81.6)]/365.25 and B=[2π·(J−2.5)]/365.25. The Julian date J may be a decimal number representing the present day in the year. For example, the Julian date J may equal one for January 1, two for January 2, three for January 3, and so on. The solar time tₛₒₗₐᵣ may be calculated as a function of the standard time tₛ, the equation of time ET, a standard meridian SM of the time zone of the location of the building, and the longitude λ, for example, using the equation:

$${t}_{solar} = {t}_{s} + ET + [ 12 \cdot ( SM - λ ) ] / π . \qquad ( Equation 2 )$$

The standard meridian SM may be determined from the time zone of the location of the building 400. Each time zone may have a unique standard meridian, which may define a particular line of latitude within the time zone. There may be approximately 15° between the standard meridians of adjacent time zones.

The solar altitude angle θ_{S} and the solar azimuth angle θ_{Z} may be determined from a solar declination δ. The solar declination δ may define an angle of incidence of the rays of the sun on the equatorial plane of the Earth. The solar declination δ may be determined using, for example, the equation:

$$δ = 0.4093 \cdot sin [ 2 π \cdot ( J - 81 ) / 368 ] . \qquad ( Equation 3 )$$

The solar altitude angle θ_{S} at the standard time tₛ may be calculated as a function of the solar time tₛₒₗₐᵣ, the solar declination δ, and the local latitude Φ using, for example, the equation:

$$θ s = arcsin [ sin ( Φ ) \cdot sin ( δ ) - cos ( Φ ) \cdot cos ( δ ) \cdot cos ( π \cdot {t}_{solar} / 12 ) ] . \qquad ( Equation 4 )$$

The solar azimuth angle θ_{Z} at the standard time tₛ may be calculated as a function of the solar time tₛₒₗₐᵣ, the solar declination δ, and the local latitude Φ using, for example, the equation:

$$θ z = arctan [ - cos ( δ ) \cdot sin ( π \cdot {t}_{solar} / 12 ) / C ] , \qquad ( Equation 5 )$$

where C=−[cos(Φ)·sin(δ)+sin(Φ)·cos(δ)·cos(π·tₛₒₗₐᵣ/12)].

The system controller and/or the motorized window treatments may be configured to determine if the sun is positioned to shine directly on the façade 402 (e.g., if sunlight may be directly incident on the façade 402) by calculating a position metric of the sun. For example, the system controller and/or the motorized window treatments may be configured to determine if the sun is positioned to shine directly on the façade 402 by calculating the solar azimuth angle θ_{Z} of the sun at the façade 402. FIGS. 4B and 4C are top views of the building 400 illustrating the use of the solar azimuth angle θ_{Z} of the sun to determine if the sun is positioned to shine directly on the façade 402. The system controller and/or the motorized window treatments may be configured to calculate the solar azimuth angle θ_{Z} as a function of the solar time tₛₒₗₐᵣ, the solar declination δ, and the local latitude Φ using, for example, Equation 5 as shown above.

The system controller and/or the motorized window treatments may be configured to determine if the sun is positioned to shine directly on the façade 402 (e.g., if sunlight may be directly incident on the façade 402) when the solar azimuth angle θ_{Z} is within a horizontal direct-sun range that extends from a first façade limit 460 to a second façade limit 470 (e.g., as shown in FIGS. 4B and 4C). The first façade limit 460 may be characterized by a first façade limit angle θ_{FL1} and the second façade limit 470 may be characterized by a second façade limit angle θ_{FL2}. For example, the first façade limit angle θ_{FL1} may be determined by adding the first offset angle θ_{OFF1} to the façade angle θ_{F} (e.g., θ_{FL1}=θ_{F}+θ_{OFF1}) and the second façade limit angle θ_{FL2} may be determine by adding the second offset angle θ_{OFF2} to the façade angle θ_{F} (e.g., θ_{FL2}=θ_{F}+θ_{OFF2}). In some examples, the first offset angle θ_{OFF1} may be approximately −90° and the second offset angle θ_{OFF2} may be approximately 90°, such that the horizontal direct-sun range spans approximately 180° (e.g., as shown in FIG. 4B). In addition, the first offset angle θ_{OFF1} and the second offset angle θ_{OFF2} may be set (e.g., initially set) to −90° and 90°, respectively, as default values, and/or may be adjusted from the default values (e.g., as shown in FIG. 4C). The system controller and/or the motorized window treatments may be configured to store the façade angle θ_{F}, the first and second offset angles θ_{OFF1}, θ_{OFF2}, and/or the first and second façade limit angles θ_{FL1}, θ_{FL2} in memory (e.g., as configuration data).

The system controller and/or the motorized window treatments may be configured to cause the motorized window treatments to be in the direct-sun state when the solar azimuth angle θ_{Z} is within the horizontal direct-sun range. In addition, the system controller and/or the motorized window treatments may be configured to cause the motorized window treatments to be in the view state when the solar azimuth angle θ_{Z} is not within the horizontal direct-sun range (e.g., and when the motorized window treatments are not in the privacy state, e.g., between the sunset time t_{SUNSET} and the sunrise time t_{SUNRISE}). The system controller and/or the motorized window treatments may be configured to compare the solar azimuth angle θ_{Z} of the sun to the first façade limit 460 (e.g., using the first façade limit angle θ_{FL1}) and to the second façade limit 470 (e.g., using the second façade limit angle θ_{FL2}) to determine when to cause the motorized window treatments to enter and/or exit the direct-sun state.

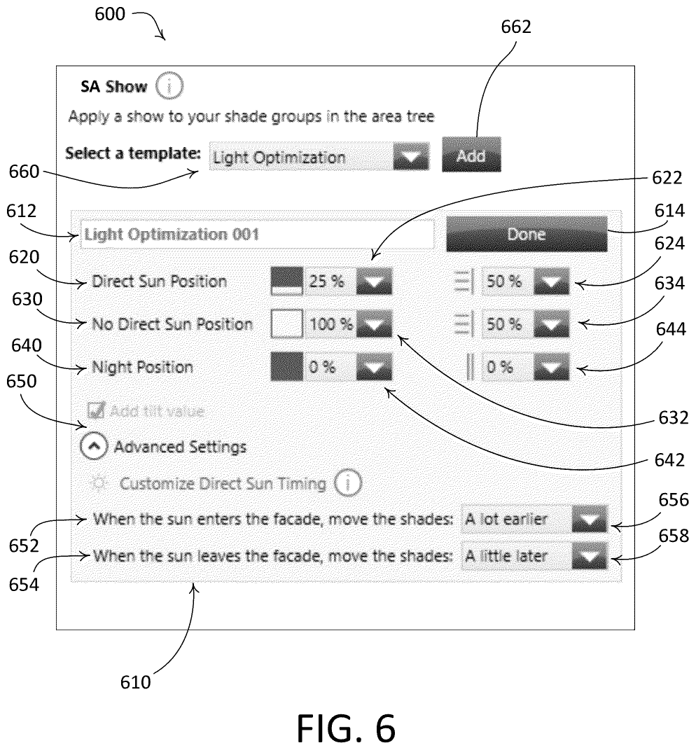

The system controller and/or the motorized window treatments may be configured to adjust the first façade limit angle θ_{FL1} and the second façade limit angle θ_{FL2} (e.g., in response to user inputs as will be described in greater detail below with reference to FIG. 6). For example, the system controller and/or the motorized window treatments may be configured to adjust the first offset angle θ_{OFF1} (e.g., and thereby the first façade limit angle θ_{FL1}) to move the first façade limit 460 either closer to the line 410 (e.g., clockwise rotation) or further from the line 410 (e.g., counterclockwise rotation). Similarly, the system controller and/or the motorized window treatments may be configured to adjust the second offset angle θ_{FL2} (e.g., and thereby the second façade limit angle θ_{FL2}) to move the second façade limit 470 either closer to the line 410 (e.g., counterclockwise rotation) or further from the line 410 (e.g., clockwise rotation). Using the northern hemisphere as an example, the effect of moving the first façade limit 460 further from line 410 causes the system controller and/or the motorized window treatments to determine to enter the direct-sun state earlier than if unmodified. Similarly, the effect of moving the first façade limit 460 closer to line 410 causes the system controller and/or the motorized window treatments to determine to enter the direct-sun state later than if unmodified. The effect of moving the second façade limit 470 closer to line 410 causes the system controller and/or the motorized window treatments to determine to leave the direct-sun state earlier than if unmodified (e.g., as shown in FIG. 4C). Similarly, the effect of moving the second façade limit 470 further from line 410 causes the system controller and/or the motorized window treatments to determine to leave the direct-sun state later than if unmodified. One will appreciate that for a motorized window treatment located in the southern hemisphere, adjustment of the first façade limit 460 (e.g., the first offset angle θ_{OFF1} and/or the first façade limit angle θ_{FL1}) sets when the system controller and/or the motorized window treatments determine to leave the direct-sun state, and adjustment of the second façade limit 470 (e.g., the second offset angle θ_{FL2} and/or the second façade limit angle θ_{FL2}) sets when the system controller and/or the motorized window treatments determine to enter the direct-sun state.

For example, the system controller and/or the motorized window treatments may be configured to store the façade angle θ_{F}, the first offset angle θ_{OFF1}, and the second offset angle θ_{OFF2} in memory and may calculate the first offset angle θ_{OFF1} and the second offset angle θ_{OFF2} when determining if the solar azimuth angle θ_{Z} is within the horizontal direct-sun range. In some examples, the system controller and/or the motorized window treatments may be configured to store the first offset angle θ_{OFF1} and the second offset angle θ_{OFF2} in memory and may adjust (e.g., directly adjust) the first offset angle θ_{OFF1} and the second offset angle θ_{OFF2} in response to received user inputs.

In some examples, the system controller and/or the motorized window treatments may be configured to determine if the sun is positioned to shine directly on the façade 402 by calculating a profile angle θ_{P} of the sun at the façade 402. The profile angle θ_{P} of the sun may be calculated using the solar altitude angle θ_{S}, the solar azimuth angle θ_{Z}, and the façade angle θ_{F} of the façade 402. The profile angle θ_{P} may define an apparent altitude of the sun relative to the façade 402 (e.g., as shown in FIG. 4A). The profile angle θ_{P} may be the angle between the line 410 that is normal to the façade 402 and a line 450 that is the projection of the line 430 that is directed towards the sun onto a vertical plane that extends through the line 410 that is normal to the façade 402. The profile angle θ_{P} may be calculated as a function of the solar altitude angle θ_{S} and a façade azimuth angle θ_{FZ} using, for example, the equation:

$${θ}_{P} = arctan [ sin ( θ s ) / cos ( {θ}_{FZ} ) ] , \qquad ( Equation 6 )$$

where the façade azimuth angle θ_{FZ} is the difference between the solar azimuth angle θ_{Z} and the façade angle θ_{F} of the façade 402 (e.g., θ_{FZ} θ_{Z}−θ_{F}). The system controller and/or the motorized window treatments may be configured to determine if the sun is positioned to shine directly on the façade 402 when the profile angle θ_{P} is within a vertical direct-sun range that extends from a first profile limit angle θ_{PL1} and a second profile limit angle θ_{PL2}. For example, the first profile limit angle θ_{PL1} may be approximately 0° and the second profile limit angle θ_{PL2} may be approximately 90°. When the profile angle θ_{P} is between the first profile limit angle θ_{PL1} and the second profile limit angle θ_{PL2}, the sun may be positioned to shine on the façade 402 (e.g., on a sunny day). When the profile angle θ_{P} is less than first profile limit angle θ_{PL1}, the sun may be past the horizon (e.g., before sunrise and/or after sunset). When the profile angle θ_{P} is greater than second profile limit angle θ_{PL2}, the sun may have passed over the top of the building 400.

The system controller and/or the motorized window treatments may be configured to calculate the position metric (e.g., the solar azimuth angle θ_{Z} and/or the profile angle θ_{P}) of the sun with respect to the façade 402 to determine the times at which the sun may be positioned to shine directly on the façade 402 during the upcoming day. The system controller and/or the motorized window treatments may be configured to generate the timeclock events of the timeclock schedule to cause the motorized window treatments to adjust to the direct-sun state when the sun is positioned to shine directly on the façade 402, and to cause the motorized window treatments to adjust to the view state when the sun is not positioned to shine directly on the façade 402 during the upcoming day. For example, the system controller and/or the motorized window treatments may be configured to create one or more sun-enter events, which each may occur at a corresponding sun-enter time t_{S-ENTER} at which to control the motorized window treatments to the direct-sun state during the upcoming day. In addition, the system controller and/or the motorized window treatments may be configured to create one or more sun-exit events, which each may occur at a corresponding sun-exit time t_{S-EXIT} at which to control the motorized window treatments to the view state during the upcoming day.

The system controller and/or the motorized window treatments may be configured to generate the timeclock events of the timeclock schedule to cause the motorized window treatments to adjust to the privacy state relative to the sunset time t_{SUNSET} (e.g., starting at or shortly after sunset) and ending at the sunrise time t_{SUNRISE}. For example, the system controller and/or the motorized window treatments may be configured to determine a privacy time t_{PRIV} at which to control the motorized blinds to the privacy state based on the sunset time t_{SUNSET} for the upcoming day. In addition, the system controller and/or the motorized window treatments may be configured to generate the timeclock events of the timeclock schedule to cause the motorized window treatments to adjust to the privacy state between predetermined times that may be preconfigured by a user of the load control system of the building 400. Depending upon the hemisphere in which the building 400 is located, the solar azimuth angle θ_{Z} of the sun may traverse one of the first façade limit angle θ_{FL1} and the second façade limit angle θ_{FL2} when entering the horizontal direct-sun range and may traverse other of the first façade limit angle θ_{FL1} and the second façade limit angle θ_{FL2} when exiting the horizontal direct-sun range. Similarly, the profile angle θ_{P} of the sun may traverse one of the first profile limit angle θ_{PL1} and the second profile limit angle θ_{PL2} when entering the horizontal direct-sun range and may traverse other of the first profile limit angle θ_{PL1} and the second profile limit angle θ_{PL2} when exiting the horizontal direct-sun range.

The operation of the motorized window treatments in the shade automation mode may be configured using a design configuration application (e.g., a design configuration software). The design configuration application may be used to set the façade angle θ_{F} of each of the motorized window treatments in the load control system. For example, each of the motorized window treatments of the load control system may be assigned to one of the four different cardinal directions (e.g., north, east, south, and west) or the four different ordinal directions (e.g., north-east, south-east, south-west, and north-west). For example, the façade angle θ_{F} of each of the motorized window treatments may be set to a predetermined angle that is associated with the one of the eight cardinal and ordinal directions to which the respective motorized window treatment is assigned. In some examples, the façade angle θ_{F} of each of the motorized window treatments may be set to any angle (e.g., between 0° and 360° and/or between −180° and 180°). The system controller and/or the motorized window treatments may be configured to use the façade angle θ_{F} (e.g., one of the eight cardinal and ordinal directions) and the geographic position (e.g., the longitude λ and the latitude Φ) to determine different event times for the timeclock schedule.

The system controller and/or the motorized window treatments may be configured to generate timeclock schedules for a plurality (e.g., all) of the motorized window treatments installed in the building 400. For example, the system controller may be configured to generate timeclock schedules (e.g., individual timeclock schedules) with different event times depending upon the value of the façade angle θ_{F} of the façade of the building 400 on which each of the plurality of motorized window treatments are located. The system controller may be configured to combine the timeclock schedules together to generate a system timeclock schedule for the entire building 400. The system controller may be configured to transmit the individual timeclock schedules to the motorized window treatments on the respective façades of the building and/or transmit the system timeclock schedule to all of the motorized window treatments in the building. Additionally and/or alternatively, the system controller may be configured to transmit commands for adjusting the motorized window treatments to the view, direct-sun, and/or privacy states (e.g., based on the individual timeclock schedules) to each of the motorized window treatments on the respective façades of the building. In addition, each of the motorized window treatments in the building 400 may be configured to generate a respective individual timeclock schedule for controlling itself during the upcoming day.

FIG. 4D shows an example system timeclock schedule 490 for a particular day of the year for a building located at a particular location. For example (e.g., for description purposes), the motorized window treatments of the building may be located on the North, East, South, and West façades of the building. The event times may be calculated based on when direct sunlight may be shining on the different façades. The motorized window treatments on the different façades may be controlled to the view state, a direct-sun state, and a privacy state positions at the different event times. Each column underneath the different façades may represent an individual timeclock schedule that may be transmitted to only the motorized window treatments located on that façade. Empty boxes indicate that the motorized window treatments should remain in their current position at that time.

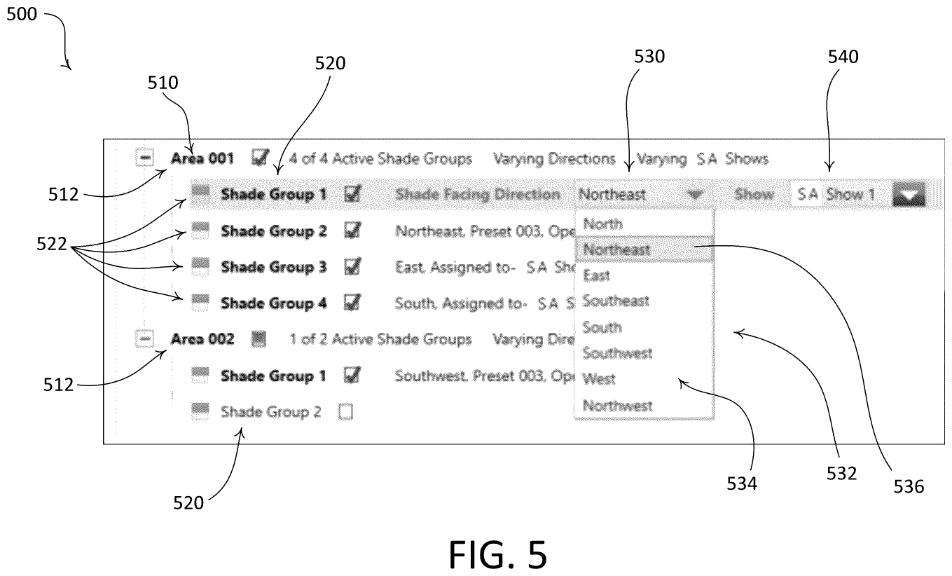

FIG. 5 illustrates an example screen 500 (e.g., a graphical user interface (GUI) window) that may be used to configure one or more motorized window treatments for operation during a shade automation mode. The motorized window treatments may be part of a load control system (e.g., the load control system 100) installed in a building (e.g., the building 400 shown in FIGS. 4A-4C). For example, the screen 500 may be displayed on a visible display of a network device (e.g., the visible display of the network device 190). The screen 500 may be used to set a façade angle θ_{F} and a shade automation (SA) show for one or more groups of motorized window treatments (e.g., shade groups). The shade automation show may define one or more characteristics that may be used to generate the timeclock schedule for each of the motorized window treatment each day.

The screen 500 may display an area list 510 that includes area names 512 of one or more areas in a building (e.g., the building 400). The screen 500 may also display a respective shade group list 520 (e.g., a window treatment group list) under one or more of the area names 512. Each of the shade group lists 520 may include one or more shade group names 522 (e.g., window treatment group names) that indicate groups of shades (e.g., motorized window treatments) in each of the respective areas (e.g., as identified by the respective area name 512). For example, the shades of each of the shade groups (e.g., as indicated by the respective shade group name 522) may be controlled as a group after installation of the load control system. A shade group may include one or more window treatments (e.g., shades).

Each of the shade groups (e.g., as indicated by the respective shade group name 522) may include a façade direction field 530 that may indicate the direction of the façade on which the shades of the shade group are to be installed and/or are installed. When the façade direction field 530 of one of the shade groups is selected, the screen 500 may display a façade direction pull-down menu 532 that may include a façade direction list 534. For example, the façade direction list 534 may include the names of the eight different cardinal and ordinal directions. Each of the eight cardinal and ordinal directions may be associated with a value for the façade angle θ_{F} of the façade on which the motorized window treatments of the shade group are located. For example, selecting North may set the façade angle θ_{F} equal to 180°, selecting Northeast may set the façade angle θ_{F} equal to −135°, selecting East may set the façade angle θ_{F} equal to −90°, selecting Southeast may set the façade angle θ_{F} equal to −45°, selecting South may set the façade angle θ_{F} equal to 0°, selecting Southwest may set the façade angle θ_{F} equal to 45°, selecting West may set the façade angle θ_{F} equal to 90°, and selecting Northwest may set the façade angle θ_{F} equal to 135°. The façade direction pull-down menu 532 may indicate a selection façade direction 536 of the façade direction list 534 (e.g., Northeast as shown in FIG. 5). In some examples, the façade direction field 530 may allow the user to enter (e.g., manually enter) a value for the façade angle θ_{F} (e.g., to any angle between 0° and 360° and/or between −180° and 180°).

Each of the shade groups (e.g., as indicated by the respective shade group name 522) may also include a shade automation field 540. The shade automation field 540 may indicate a name of a shade automation (SA) show that may define the operation of the motorized window treatments of the shade group when operating in the shade automation mode (e.g., as will be described in greater detail below). When the shade automation field 540 of one of the shade groups is selected, the screen 500 may display a shade automation pull-down menu (not shown). While not shown in FIG. 5, the shade automation pull-down menu may operate similar to the façade direction pull-down menu 532 and may include a shade automation show name list having the names of various shade automation shows. In addition, the shade automation show name list of the shade automation pull-down menu may also display an option for creating a new shade automation show. The shade automation field 540 may indicate a selected one of the shade automation shows (e.g., “SA Show 1” as show in FIG. 5).

FIG. 6 illustrates an example screen 600 (e.g., a graphical user interface (GUI) window) that may be used to configure one or more motorized window treatments for operation during the shade automation mode. The motorized window treatments may be part of a load control system (e.g., the load control system 100) installed in a building (e.g., the building 400 shown in FIGS. 4A-4C). For example, the screen 600 may be displayed on a visible display of a network device (e.g., the visible display of the network device 190). The screen 600 may be used to create a new shade automation (SA) show for one or more groups of motorized window treatments (e.g., shade groups). The shade automation show may define one or more characteristics that may be used to generate the timeclock schedule for each of the motorized window treatment in a shade group each day. For example, the screen 600 may be displayed in response to a selection of the option for creating a new shade automation show in the shade automation show name list of the shade automation pull-down menu for the shade automation field 540 of the screen 500 shown in FIG. 5.

The screen 600 may comprise a shade automation show configuration area 610, which may allow for a user to input the one or more characteristics that may be used to generate the timeclock schedule for each of the motorized window treatments for each day. The shade automation show configuration area 610 may comprise a shade automation show name field 612, which may allow the user to assign a name (e.g., a unique name) to the shade automation show that is presently being configured. The shade automation show configuration area 610 may also comprise a done button 614, which may be actuated by the user to save the one or more characteristics that were entered by the user into the shade automation show configuration area 610. After the done button 614 is actuated by the user, the name entered into the shade automation show name field 612 may be added to the shade automation show name list of the shade automation pull-down menu for the shade automation field 540 of the screen 500 shown in FIG. 5.

The shade automation show configuration area 610 may comprise a direct-sun state configuration portion 620 (e.g., a direct sun position configuration portion), a view state configuration portion 630 (e.g., a no direct sun position configuration portion), and/or a privacy state configuration portion 640 (e.g., a night position configuration portion). The direct-sun state configuration portion 620 may comprise a direct-sun position field 622 for allowing the user to select a position to which motorized roller shades of the shade group may be controlled when in the direct-sun state, and a direct-sun tilt angle field 624 for allowing the user to select a tilt angle to which motorized blinds of the shade group may be controlled when in the direct-sun state. One will recognize that other fields may be used and/or added for other types of motorized window treatments. The view state configuration portion 630 may comprise a view position field 632 for allowing the user to select a position to which motorized roller shades of the shade group may be controlled when in the view state, and a view tilt angle field 634 for allowing the user to select a tilt angle to which motorized blinds of the shade group may be controlled when in the view state. The privacy state configuration portion 640 may comprise a privacy position field 642 for allowing the user to select a position to which motorized roller shades of the shade group may be controlled when in the privacy state, and a privacy tilt angle field 644 for allowing the user to select a tilt angle to which motorized blinds of the shade group may be controlled when in the privacy state. Each of the direct-sun position field 622, the direct-sun tilt angle field 624, the view position field 632, the view tilt angle field 634, the privacy position field 642, and the privacy tilt angle field 644 may present respective pull-down menus having respective lists of positions or tilt angles that may be selected by a user for controlling the motorized window treatments when in the respective state. In addition, the user may be configured to enter a value into each of the direct-sun position field 622, the direct-sun tilt angle field 624, the view position field 632, the view tilt angle field 634, the privacy position field 642, and the privacy tilt angle field 644 to provide the position or tilt angle to which the motorized window treatments may be controlled when in the respective state. As one will recognize, a shade group may include different types (e.g., shades, blind, etc.) of motorized window treatments.

The shade automation show configuration area 610 may also comprise an advanced settings area 650, which may allow the user to adjust a direct-sun range (e.g., a horizontal direct-sun range) to which the solar azimuth angle θ_{Z} of the sun may be compared, for example, to determine (e.g., by the system controller and/or the motorized window treatments) to when to control the motorized window treatments of the shade group to the direct-sun state. For example, the network device may be configured to adjust a first offset angle θ_{OFF1} and/or a second offset angle θ_{OFF2} in response to inputs received via the advanced settings area 650. The first offset angle θ_{OFF1} and/or the second offset angle θ_{OFF2} may be used (e.g., by the system controller and/or the motorized window treatments) to determine the first façade limit angle θ_{FL1} and the second façade limit angle θ_{FL2}, respectively, which may be used define the direct-sun range and thus when the motorized window treatments of the shade group are entering and exiting the direct-sun state. The first façade limit angle θ_{FL1} may be determined by adding the first offset angle θ_{OFF1} to the façade angle θ_{F} (e.g., θ_{FL1}=θ_{F}+θ_{OFF1}) and the second façade limit angle θ_{FL2} may be determine by adding the second offset angle θ_{OFF2} to the façade angle θ_{F} (e.g., θ_{FL2}=θ_{F}+θ_{OFF2}). For example, the first offset angle θ_{OFF1} may be a negative value and the second offset angle θ_{OFF2} may be a positive value. The system controller and/or the motorized window treatments may be configured, for example, to store the façade angle θ_{F}, the first offset angle θ_{OFF1}, and the second offset angle θ_{OFF2} in memory and may calculate the first offset angle θ_{OFF1} and the second offset angle θ_{OFF2} when determining if the solar azimuth angle θ_{Z} is within the horizontal direct-sun range. In some examples, the network device may be configured to adjust (e.g., directly adjust) the first façade limit angle θ_{FL1} and the second façade limit angle θ_{FL2} in response to inputs received via the advanced settings area 650 (e.g., rather than adjusting the first offset angle θ_{OFF1} and/or a second offset angle θ_{OFF2} as described above). For example, the system controller and/or the motorized window treatments may be configured to store the first offset angle θ_{OFF1} and the second offset angle θ_{OFF2} in memory and may adjust (e.g., directly adjust) the first offset angle θ_{OFF1} and the second offset angle θ_{OFF2} in response to the inputs received via the advanced settings area 650.

The advanced settings area 650 may comprise a sun-enter adjustment portion 652 and a sun-exit adjustment portion 654. The sun-enter adjustment portion 652 may allow for adjustment by the user of a sun-enter façade limit angle θ_{FL-ENTER}, which may be, for example, the one of the first façade limit angle θ_{FL1} or the second façade limit angle θ_{FL2} that the solar azimuth angle θ_{Z} of the sun may traverse when entering the direct-sun range (e.g., depending upon the hemisphere in which the building is located). For example, the sun-enter façade limit angle θ_{FL-ENTER} may be the first façade limit angle θ_{FL1} in the northern hemisphere and the second façade limit angle θ_{FL2} in the southern hemisphere. Accordingly, the solar azimuth angle θ_{Z} may enter the direct-sun range when the solar azimuth angle θ_{Z} traverses the first façade limit angle θ_{FL1} in the northern hemisphere and when the solar azimuth angle θ_{Z} traverses the second façade limit angle θ_{FL2} in the southern hemisphere. When the solar azimuth angle θ_{Z} of the sun enters the direct-sun range (e.g., when the sun moves into position to directly shine on the façade on which the motorized window treatments of the shade group are located), the motorized window treatments of the shade group may be configured to enter the direct-sun state. For example, the system controller and/or the motorized window treatments may be configured to adjust one of the first offset angle θ_{OFF1} or the second offset angle θ_{OFF2} in response to inputs received from the user via the sun-enter adjustment portion 652 and may subsequently use the first offset angle θ_{OFF1} or the second offset angle θ_{OFF2} to calculate the first façade limit angle θ_{FL1} or the second façade limit angle θ_{FL2}, respectively. In some examples, the system controller and/or the motorized window treatments may be configured to adjust (e.g., directly adjust) the first façade limit angle θ_{FL1} and the second façade limit angle θ_{FL2} in response to inputs received from the user via the sun-enter adjustment portion 652.

The sun-enter adjustment portion 652 may comprise a sun-enter adjustment field 656. For example, when the sun-enter adjustment field 656 is selected, the screen 600 may display a sun-enter adjustment pull-down menu that may include a sun-enter adjustment list. The sun-enter adjustment list may provide a list of options that allow the user to adjust the sun-enter façade limit angle θ_{FL-ENTER} (e.g., by adjusting the first offset angle θ_{OFF1} or the second offset angle θ_{OFF2}). For example, the list of options of the sun-enter adjustment list may comprise an “a lot earlier” option, an “a little earlier” option, an “on time” option, an “a little later” option, and an “a lot later” option. Each of the options of the sun-enter adjustment list other than the “on time” option may indicate an adjustment amount (e.g., “a lot” or “a little”). For example, the “a little earlier” option and the “a little later” option may indicate an adjustment amount of a first magnitude (e.g., a first predetermined value, such as approximately 5°), and the “a lot earlier” option and the “a lot later” option may indicate an adjustment amount of a second magnitude (e.g., a second predetermined value, such as approximately 10°). For example, the second magnitude (e.g., associated with “a lot” of adjustment) may be greater than the first magnitude (e.g., associated with “a little” of adjustment), for example, twice the first magnitude. Selection of the “on time” option may indicate an adjustment amount of, for example, zero.

Each of the options of the sun-enter adjustment list other than the “on time” option may also indicate a time direction of adjustment (e.g., “earlier” or “later”). For example, for the northern hemisphere, the “a little earlier” option and the “a lot earlier” option may indicate an adjustment amount of a negative value (e.g., approximately −5° or −10°), which may cause the sun-enter façade limit angle θ_{FL-ENTER} to move further away from the façade angle θ_{F} (e.g., the sun-enter event may occur earlier in time). When in the northern hemisphere, the first façade limit 460 (e.g., as shown in FIG. 4B) may move, for example, by the adjustment amount in the counter-clockwise direction to cause the motorized treatment to enter the direct-sun state earlier (e.g., “a little earlier” and the “a lot earlier”). Further, for the northern hemisphere, the “a little later” option and the “a lot later” option may indicate an adjustment amount having of a positive value (e.g., approximately 5° or 10°), which may cause the sun-enter façade limit angle θ_{FL-ENTER} to move closer to the façade angle θ_{F} (e.g., the sun-enter event may occur later in time). When in the northern hemisphere, the first façade limit 460 (e.g., as shown in FIG. 4B) may move, for example, by the adjustment amount in the clockwise direction to cause the motorized treatment to enter the direct-sun state later (e.g., “a little later” and the “a lot later”). For the southern hemisphere, the adjustment amount may be a positive value (e.g., approximately 5° or 10°) when the “a little earlier” option or the “a lot earlier” option are selected, and a negative value (e.g., approximately −5° or −10°) when the “a little later” option or the “a lot later” option are selected.

The sun-exit adjustment portion 654 may allow for adjustment by the user of a sun-exit façade limit angle θ_{FL-EXIT}, which may be, for example, the one of the first façade limit angle θ_{FL1} or the second façade limit angle θ_{FL2} that the solar azimuth angle θ_{Z} of the sun may traverse when exiting the direct-sun range (e.g., depending upon the hemisphere in which the building is located). For example, the sun-exit façade limit angle θ_{FL-EXIT} may be the second façade limit angle θ_{FL2} in the northern hemisphere and the first façade limit angle θ_{FL1} in the southern hemisphere. Accordingly, the solar azimuth angle θ_{Z} may exit the direct-sun range when the solar azimuth angle θ_{Z} traverses the second façade limit angle θ_{FL2} in the northern hemisphere and when the solar azimuth angle θ_{Z} traverses the first façade limit angle θ_{FL1} in the southern hemisphere. When the solar azimuth angle θ_{Z} of the sun exits the direct-sun range (e.g., when the sun moves out of position to directly shine on the façade on which the motorized window treatments of the shade group are located), the motorized window treatments of the shade group may be configured to exit the direct-sun state. For example, the system controller and/or the motorized window treatments may be configured to adjust one of the first offset angle θ_{OFF1} or the second offset angle θ_{OFF2} in response to inputs received from the user via the sun-enter adjustment portion 654, and may subsequently use the first offset angle θ_{OFF1} or the second offset angle θ_{OFF2} to calculate the first façade limit angle θ_{FL1} or the second façade limit angle θ_{FL2}, respectively.

The sun-exit adjustment portion 654 may comprise a sun-exit adjustment field 658. For example, when the sun-exit adjustment field 658 is selected, the screen 600 may display a sun-exit adjustment pull-down menu that may include a sun-exit adjustment list. The sun-exit adjustment list may provide a list of options that allow a user to adjust the sun-exit façade limit angle θ_{FL-EXIT} (e.g., by adjusting the first offset angle θ_{OFF1} or the second offset angle θ_{OFF2}). For example, the list of options of the sun-enter adjustment list may comprise an “a lot earlier” option, an “a little earlier” option, an “on time” option, an “a little later” option, and an “a lot later” option. Each of the options of the sun-exit adjustment list other than the “on time” option may indicate an adjustment amount (e.g., “a lot” or “a little”). For example, the “a little earlier” option and the “a little later” option may indicate an adjustment amount of a first magnitude (e.g., a first predetermined value, such as approximately 5°), and the “a lot earlier” option and the “a lot later” option may indicate an adjustment amount of a second magnitude (e.g., a second predetermined value, such as approximately 10°). For example, the second magnitude (e.g., associated with “a lot” of adjustment) may be greater than the first magnitude (e.g., associated with “a little” of adjustment), for example, twice the first magnitude. Selection of the “on time” option may indicate an adjustment amount of, for example, zero.

Each of the options of the sun-exit adjustment list other than the “on time” option may also indicate a time direction of adjustment (e.g., “earlier” or “later”). For example, for the northern hemisphere, the “a little earlier” option and the “a lot earlier” option may indicate an adjustment amount of a negative value (e.g., approximately −5° or −10°), which may cause the sun-exit façade limit angle θ_{FL-EXIT} to move closer to the façade angle θ_{F} (e.g., the sun-exit event may occur earlier in time). When in the northern hemisphere, the second façade limit 470 (e.g., as shown in FIG. 4B) may move, for example, by the adjustment amount in the counter-clockwise direction to cause the motorized treatment to exit the direct-sun state earlier (e.g., “a little earlier” and the “a lot earlier”). Further, the “a little later” option and the “a lot later” option may indicate an adjustment amount of a positive value (e.g., approximately 5° or 10°), which may cause the sun-exit façade limit angle θ_{FL-EXIT} to farther away from the façade angle θ_{F} (e.g., the sun-exit event may occur later in time). When in the northern hemisphere, the second façade limit 470 (e.g., as shown in FIG. 4B) may move, for example, by the adjustment amount in the clockwise direction to cause the motorized treatment to exit the direct-sun state later (e.g., “a little later” and the “a lot later”). For the southern hemisphere, the adjustment amount may be a positive value (e.g., approximately 5° or 10°) when the “a little earlier” option or the “a lot earlier” option are selected, and a negative value (e.g., approximately −5° or −10°) when the “a little later” option or the “a lot later” option are selected.

The screen 600 may also comprise a template selection field 660. The template selection field 660 may allow for a selection of one of a number of shade automation templates, which may populate one or more fields of the shade automation show configuration area 610 with respective predetermined values. For example, each of the shade automation templates may be defined predetermined values for the direct-sun position field 622, the direct-sun tilt angle field 624, the view position field 632, the view tilt angle field 634, the privacy position field 642, and the privacy tilt angle field 644 of the shade automation show configuration area 610. When the template selection field 660 is selected by the user, the screen 600 may display a template selection pull-down menu (not shown) that may include a template name list having the names of various shade automation templates. The shade automation templates may include, for example, a “light optimization” template, a “fade fighter” template, a “glare control” template, and/or a “view optimization” template. For example, selection of the “light optimization” template by the user may populate the fields with values to create a shade automation show that balances minimizing glare and providing view; selection of the “fade fighter” template may populate the fields with values to create a shade automation show that prioritizes blocking direct sun; selection of the “glare control” template may populate the fields with values to create a shade automation show that prioritizes glare control and blocking high light levels; and selection of the “view optimization” template may populate the fields with values to create a shade automation show that prioritizes providing view and high light levels. When one of the shade automation templates of the template name list of the template selection pull-down menu of the template selection field 660 is selected, the user may actuate an add button 662 to cause the fields of the shade automation show configuration area 610 to be populated with the respective predetermined values of the selected shade automation template.

A control device of a load control system that includes motorized window treatments (e.g., motorized roller shades and/or motorized blinds) may configure a direct-sun range of a shade automation show for controlling the motorized window treatments. For example, the control device may be a processing device, such as a system controller (e.g., the system controller 110), and/or one or more of the motorized window treatments of the load control system (e.g., the motor drive units 156, 166, 250, 350 of the motorized window treatments 150, 160, 200, 300, respectively). The direct-sun range of the shade automation show may be defined by, for example, a first façade limit angle θ_{FL1} and/or a second façade limit angle θ_{FL2}. The control device may be configured to update configuration data stored in memory (e.g., one or more of first and second offset angles θ_{OFF1}, θ_{OFF2} and/or first and second façade limit angles θ_{FL1}, θ_{FL2} of the shade automation show) in response to a user input received, for example, via the screen 600 shown in FIG. 6. The control device may be configured to generate the timeclock events of the timeclock schedule to cause the motorized window treatments to adjust to a direct-sun state when the sun is positioned to shine directly on the façade during the upcoming day. For example, the control device may be configured to create one or more sun-enter events, which each may occur at a corresponding sun-enter event time t_{S-ENTER} at which to control the motorized window treatments to the direct-sun state during the upcoming day. In addition, the control device may be configured to create one or more sun-exit events, which each may occur at a corresponding sun-exit event time t_{S-EXIT} at which to control the motorized window treatments to the view state during the upcoming day.

In some examples, the control device may be configured to automatically configure the direct-sun range of the shade automation show. For example, the control device may be configured to automatically configure the direct-sun range of the shade automation show for one of the motorized window treatments in a building in which the load control system is installed in response to a light intensity outside of a building as measured at the façade of the building on which the motorized window treatment is installed. The control device may be configured to determine the light intensity outside of the building in response to a sensing circuit configured to measure the light intensity outside of the building at the façade of the building on which the motorized window treatment is installed. For example, the control device may be configured to receive a message that includes the light intensity outside of the building from a window sensor (e.g., the window sensor 186) that may be mounted to the window that the motorized window treatment is configured to cover (e.g., and/or to a window near the window that the motorized window treatment is configured to cover). In addition, the control device may be configured to receive a message that includes the light intensity outside of the building from the motorized window treatment, which may be configured to determine the light intensity outside of the building from an integral photosensor (e.g., the photosensor on the motor drive units 156, 166 and/or on the headrail 164) and/or one or more integral solar cells (e.g., the solar cells located on the bottom bars 155, 165 of the motorized window treatments 150, 160). Further, when the control device is one of the motorized window treatments, the control device may be configured to determine the light intensity outside of the building directly in response to the integral photosensor and/or the one or more integral solar cells.

The control device may be configured to determine whether direct sunlight is presently shining on (e.g., is presently incident) the façade of the building on which the motorized window treatment is located. For example, since the light intensity outside of the building is measured at the façade (e.g., by the window sensor, the integral photosensor, and/or the one or more integral solar cells), the control device may be configured to determine whether direct sunlight is presently shining on the façade in response to a magnitude of the light intensity outside of the building. The control device may be configured to compare the measured light intensity to a sun-enter threshold L_{TH-ENTER} and to determine that direct sunlight is presently shining on the façade when the measured light intensity exceeds (e.g., is greater than or equal to) the sun-enter threshold L_{TH-ENTER}. The control device may be configured to compare the measured light intensity to a sun-exit threshold L_{TH-EXIT} and to determine that direct sunlight is not presently shining on the façade when the measured light intensity does not exceed (e.g., is less than or equal to) the sun-exit threshold L_{TH-EXIT}. For example, the sun-enter threshold L_{TH-ENTER} may be greater than the sun-exit threshold L_{TH-EXIT} to provide some hysteresis in the determination of whether direct sunlight is presently shining on the façade or not.

The control device may be configured to determine whether direct sunlight is shining on the façade at the correct times as compared the sun-enter event time t_{S-ENTER} and the sun-exit event time t_{S-EXIT} of the direct-sun range of the shade automation show. The control device may be configured to determine a sun-enter actual time t_{ACT-ENTER} at which direct sunlight began to shine on the façade and/or a sun-exit actual time t_{ACT-EXIT} at which direct sunlight stopped shining on the façade in response to the magnitude of the light intensity outside of the building. For example, near the sun-enter event time t_{S-ENTER} (e.g., in a time period window around the sun-enter time t_{S-ENTER}), the control circuit may be configured to determine when the measured light intensity rises above (e.g., becomes greater than or equal to) the sun-enter threshold L_{TH-ENTER}, and set the sun-enter actual time t_{ACT-ENTER} equal to the time at which the measured light intensity rises above (e.g., becomes greater than) the sun-enter threshold L_{TH-ENTER}. In addition, near the sun-exit event time t_{S-EXIT} (e.g., in a time period window around the sun-exit time t_{S-EXIT}), the control circuit may be configured to determine when the measured light intensity falls below (e.g., becomes less than) the sun-exit threshold L_{TH-EXIT}, and set the sun-exit actual time t_{A}CT-EXIT equal to the time at which the measured light intensity falls below (e.g., becomes less than) the sun-exit threshold L_{TH-EXIT}.

The control device may be configured to compare the sun-enter actual time t_{ACT-ENTER} to the sun-enter event time t_{S-ENTER}, and to compare the sun-exit actual time t_{ACT-EXIT} to the sun-exit event time t_{S-EXIT}. For example, the control device may be configured to compare the sun-enter actual time t_{ACT-ENTER} to the sun-enter event time t_{S-ENTER} by determining a difference Δ_{DIFF-ENTER} between the sun-enter actual time t_{ACT-ENTER} and the sun-enter event time t_{S-ENTER} (e.g., Δ_{DIFF-ENTER}=t_{ACT-ENTER}−t_{S-ENTER}). In addition, the control device may be configured to compare the sun-exit actual time t_{ACT-EXIT} to the sun-exit event time t_{S-EXIT} by determining a difference Δ_{DIFF-EXIT} between the sun-exit actual time t_{ACT-EXIT} and the sun-exit event time t_{S-EXIT} (e.g., Δ_{DIFF-EXIT}=t_{ACT-EXIT}−t_{S-EXIT}).

The control device may be configured to determine to adjust (e.g., automatically adjust) the configuration of the direct-sun range of the shade automation show in response to the comparison between the sun-enter actual time t_{ACT-ENTER} and the sun-enter event time t_{S-ENTER}, and/or the comparison between the sun-exit actual time t_{ACT-EXIT} and the sun-exit event time t_{S-EXIT}. For example, the control device may be configured to determine to adjust (e.g., automatically adjust) the configuration of the direct-sun range of the shade automation show in response to the difference Δ_{DIFF-ENTER} between the sun-enter actual time t_{ACT-ENTER} and the sun-enter event time t_{S-ENTER}, and/or the difference Δ_{DIFF-EXIT} between the sun-exit actual time t_{ACT-EXIT} and the sun-exit event time t_{S-EXIT}. The control device may be configured to determine to adjust a sun-enter façade limit angle θ_{FL-ENTER}, which may be, for example, the one of the first façade limit angle θ_{FL1} or the second façade limit angle θ_{FL2} that the solar azimuth angle θ_{Z} of the sun may traverse when entering the direct-sun range (e.g., depending upon the hemisphere in which the building is located). In addition, the control device may be configured to determine to adjust a sun-exit façade limit angle θ_{FL-EXIT}, which may be, for example, the one of the first façade limit angle θ_{FL1} or the second façade limit angle θ_{FL2} that the solar azimuth angle θ_{Z} of the sun may traverse when exiting the direct-sun range (e.g., depending upon the hemisphere in which the building is located).

The control device may be configured to adjust (e.g., automatically adjust) the sun-enter façade limit angle θ_{FL-ENTER} to move the sun-enter event time t_{S-ENTER} closer to the sun-enter actual time t_{ACT-ENTER}, and/or to adjust the sun-exit façade limit angle θ_{FL-EXIT} to move the sun-exit event time t_{S-EXIT} closer to the sun-exit actual time t_{ACT-EXIT}. For example, the control device may be configured to determine to adjust the sun-enter façade limit angle θ_{FL-ENTER} in response to the difference Δ_{DIFF-ENTER} between the sun-enter actual time t_{ACT-ENTER} and the sun-enter event time t_{S-ENTER}, and/or to determine to adjust the sun-exit façade limit angle θ_{FL-EXIT} in response to the difference Δ_{DIFF-EXIT} between the sun-exit actual time t_{ACT-EXIT} and the sun-exit event time t_{S-EXIT}. For example, the control device may be configured to determine to adjust the sun-enter façade limit angle θ_{FL-ENTER} when an absolute value of the difference Δ_{DIFF-ENTER} exceeds (e.g., is greater than) a first difference threshold Δ_{TH1}. When the absolute value of the difference Δ_{DIFF-ENTER} between the sun-enter actual time t_{ACT-ENTER} and the sun-enter event time t_{S-ENTER} does not exceed (e.g., is less than) the first difference threshold Δ_{TH1}, the control circuit may not adjust the sun-enter façade limit angle θ_{FL-ENTER}. In addition, the control device may be configured to determine to adjust the sun-exit façade limit angle θ_{FL-EXIT} when an absolute value of the difference Δ_{DIFF-EXIT} exceeds (e.g., is greater than) the first difference threshold Δ_{TH1}. When the absolute value of the difference Δ_{DIFF-EXIT} between the sun-exit actual time t_{ACT-EXIT} and the sun-exit event time t_{S-EXIT} does not exceed (e.g., is less than) the first difference threshold Δ_{TH1}, the control circuit may not adjust the sun-exit façade limit angle θ_{FL-EXIT}. For example, the first difference threshold Δ_{TH1} may represent an amount of time required for the azimuth angle θ_{Z} of the sun at the façade to change approximately 5°.

When the control device determines to adjust (e.g., automatically adjust) the sun-enter façade limit angle θ_{FL-ENTER} and/or the sun-exit façade limit angle θ_{FL-EXIT}, the control device may be configured to determine whether the sun-enter actual time t_{ACT-ENTER} and/or the sun-exit actual time t_{ACT-EXIT} occurred “earlier” or “later” than the sun-enter event time t_{S-ENTER} and/or the sun-exit event time t_{S-EXIT}, respectively. For example, the control device may be configured to determine that the sun-enter time t_{S-ENTER} occurred “earlier” when the difference Δ_{DIFF-ENTER} between the sun-enter actual time t_{ACT-ENTER} and the sun-enter event time t_{S-ENTER} is negative (e.g., Δ_{DIFF-ENTER}<0), and to determine that the sun-enter time t_{S-ENTER} occurred “later” when the difference Δ_{DIFF-ENTER} between the sun-enter actual time t_{ACT-ENTER} and the sun-enter event time t_{S-ENTER} is positive (e.g., Δ_{DIFF-ENTER}>0). In addition, the control device may be configured to determine that the sun-enter time t_{S-EXIT} occurred “earlier” when the difference Δ_{DIFF-EXIT} between the sun-exit actual time t_{ACT-EXIT} and the sun-exit event time t_{S-EXIT} is negative (e.g., Δ_{DIFF-EXIT}<0), and to determine that the sun-exit time t_{S-EXIT} occurred “later” when the difference Δ_{DIFF-EXIT} between the sun-exit actual time t_{ACT-EXIT} and the sun-exit event time t_{S-EXIT} is positive (e.g., Δ_{DIFF-EXIT}>0).

In addition, when the control device determines to adjust (e.g., automatically adjust) the sun-enter façade limit angle θ_{FL-ENTER} and/or the sun-exit façade limit angle θ_{FL-EXIT}, the control device may be configured to determine whether the sun-enter actual time t_{ACT-ENTER} and/or the sun-exit actual time t_{ACT-ExIT}, respectively, occurred “earlier” or “later” by “a little” or “a lot” as compared to the sun-enter event time t_{S-ENTER} and/or the sun-exit event time t_{S-EXIT}, respectively. For example, the control device may be configured to determine that the sun-enter actual time t_{ACT-ENTER} occurred “earlier” or “later” by “a lot” when the absolute value of the difference Δ_{DIFF-ENTER} between the sun-enter actual time t_{ACT-ENTER} and the sun-enter event time t_{S-ENTER} is greater than (e.g., greater than or equal to) a second difference threshold Δ_{TH2}, and to determine that the sun-enter actual time t_{ACT-ENTER} occurred “earlier” or “later” by “a little” when the absolute value of the difference Δ_{DIFF-ENTER} between the sun-enter actual time t_{ACT-ENTER} and the sun-enter event time t_{S-ENTER} is less than the second difference threshold Δ_{TH2}. In addition, the control device may be configured to determine that the sun-exit actual time t_{ACT-EXIT} occurred “earlier” or “later” by “a lot” when the absolute value of the difference Δ_{DIFF-EXIT} between the sun-exit actual time t_{ACT-EXIT} and the sun-exit event time t_{S-EXIT} is greater than (e.g., greater than or equal to) the second difference threshold Δ_{TH2}, and to determine that the sun-exit actual time t_{ACT-EXIT} occurred “earlier” or “later” by “a little” when the absolute value of the difference Δ_{DIFF-EXIT} between the sun-exit actual time t_{ACT-EXIT} and the sun-exit event time t_{S-EXIT} is less than the second difference threshold Δ_{TH2}. For example, the second difference threshold Δ_{TH2} may represent an amount of time required for the azimuth angle θ_{Z} of the sun at the façade to change approximately 10°. The second difference threshold Δ_{TH2} may be, for example, approximately twice the first difference threshold Δ_{TH1}.

The control device may be configured to determine whether the sun-enter actual time t_{ACT-ENTER} occurred “a lot earlier”, “a little earlier”, “a little later”, or “a lot later” than the sun-enter event time t_{S-ENTER}. The control device may be configured to determine that the sun-enter actual time t_{ACT-ENTER} occurred “a lot earlier” than the sun-enter event time t_{S-ENTER} when the difference Δ_{DIFF-ENTER} is negative and the absolute value of the difference Δ_{DIFF-ENTER} is greater than the second difference threshold Δ_{TH2} (e.g., Δ_{DIFF-ENTER}≤Δ_{TH2}). The control device may be configured to determine that the sun-enter actual time t_{ACT-ENTER} occurred “a little earlier” than the sun-enter event time t_{S-ENTER} when the difference Δ_{DIFF-ENTER} is negative and the absolute value of the difference Δ_{DIFF-ENTER} is greater than the first difference threshold Δ_{TH1}, but less than the second difference threshold Δ_{TH2} (e.g., Δ_{TH2}≤Δ_{DIFF-ENTER}≤Δ_{TH1}). The control device may be configured to determine that the sun-enter actual time t_{ACT-ENTER} occurred “a little later” than the sun-enter event time t_{S-ENTER} when the difference Δ_{DIFF-ENTER} is positive and the absolute value of the difference Δ_{DIFF-ENTER} is greater than the first difference threshold Δ_{TH1}, but less than the second difference threshold Δ_{TH2} Δ_{TH1}≤Δ_{DIFF-ENTER}≤Δ_{TH2}). The control device may be configured to determine that the sun-enter actual time t_{ACT-ENTER} occurred “a lot later” than the sun-enter event time t_{S-ENTER} when the difference Δ_{DIFF-ENTER} is positive and the absolute value of the difference Δ_{DIFF-ENTER} is greater than the second difference threshold Δ_{TH2} (e.g., Δ_{DIEF-ENTER}≥Δ_{TH2}).

The control device may be configured to determine whether the sun-exit actual time t_{ACT-EXIT} occurred “a lot earlier”, “a little earlier”, “a little later”, or “a lot later” than the sun-exit event time t_{S-EXIT}. The control device may be configured to determine that the sun-exit actual time t_{ACT-EXIT} occurred “a lot earlier” than the sun-exit event time t_{S-EXIT} when the difference Δ_{DIFF-EXIT} is negative and the absolute value of the difference Δ_{DIFF-EXIT} is greater than the second difference threshold Δ_{TH2} (e.g., Δ_{DIFF-EXIT}≤Δ_{TH2}). The control device may be configured to determine that the sun-exit actual time t_{A}CT-EXIT occurred “a little earlier” than the sun-exit event time t_{S-EXIT} when the difference Δ_{DIFF-EXIT} is negative and the absolute value of the difference Δ_{DIFF-EXIT} is greater than the first difference threshold Δ_{T}m, but less than the second difference threshold Δ_{TH2} (e.g., Δ_{TH2}≤Δ_{DIFF-EXIT}≤Δ_{TH1}). The control device may be configured to determine that the sun-exit actual time t_{ACT-EXIT} occurred “a little later” than the sun-exit event time t_{S-EXIT} when the difference Δ_{DIFF-EXIT} is positive and the absolute value of the difference Δ_{DIFF-EXIT} is greater than the first difference threshold Δ_{TH1}, but less than the second difference threshold Δ_{TH2} Δ_{TH1}≤Δ_{DIFF-EXIT}≤Δ_{TH2}). The control device may be configured to determine that the sun-exit actual time t_{ACT-EXIT} occurred “a lot later” than the sun-exit event time t_{S-EXIT} when the difference Δ_{DIFF-EXIT} is positive and the absolute value of the difference Δ_{DIFF-EXIT} is greater than the second difference threshold Δ_{TH2} (e.g., Δ_{DIFF-EXIT}≥Δ_{TH2}).

The control device may be configured to adjust (e.g., automatically adjust) the the sun-enter façade limit angle θ_{FL-ENTER} and/or the sun-exit façade limit angle θ_{FL-EXIT} in response to determining whether the sun-enter actual time t_{ACT-ENTER} and/or the sun-exit actual time t_{ACT-EXIT} occurred “a lot earlier”, “a little earlier”, “a little later”, or “a lot later” than the sun-enter event time t_{S-ENTER} and/or the sun-exit event time t_{S-EXIT}, respectively. For example, when the control circuit determines that the sun-enter actual time t_{ACT-ENTER} and/or the sun-exit actual time t_{ACT-EXIT} occurred “a little earlier” or “a little later”, the control device may be configured to adjust the sun-enter façade limit angle θ_{FL-ENTER} and/or the sun-exit façade limit angle θ_{FL-EXIT}, respectively, by an adjustment amount of a first magnitude (e.g., a first predetermined value, such as approximately 5°). In addition, when the control circuit determines that the sun-enter actual time t_{ACT-ENTER} and/or the sun-exit actual time t_{ACT-EXIT} occurred “a lot earlier” or “a lot later”, the control device may be configured to adjust the sun-enter façade limit angle θ_{FL-ENTER} and/or the sun-exit façade limit angle θ_{FL-EXIT}, respectively, by an adjustment amount of a second magnitude (e.g., a second predetermined value, such as approximately 10°). For example, the second magnitude (e.g., associated with “a lot” of adjustment) may be greater than the first magnitude (e.g., associated with “a little” of adjustment), for example, twice the first magnitude.

The control device may also be configured to determine a time direction of adjustment (e.g., “earlier” or “later”) of the sun-enter façade limit angle θ_{FL-ENTER} and/or the sun-exit façade limit angle θ_{FL-EXIT} (e.g., based on whether the building in which the load control system is located is in the northern hemisphere or the southern hemisphere). For example, for the northern hemisphere, when the control circuit determines that the sun-enter actual time t_{ACT-ENTER} and/or the sun-exit actual time t_{ACT-EXIT} occurred “a little earlier” or “a lot earlier”, the control device may be configured to adjust sun-enter façade limit angle θ_{FL-ENTER} and/or the sun-exit façade limit angle θ_{FL-EXIT}, respectively, by an adjustment amount having a negative value (e.g., approximately −5° or −10°), which may cause the sun-enter façade limit angle θ_{FL-ENTER} to move further away from the façade angle θ_{F} (e.g., the sun-enter event may occur earlier in time). In addition, for the northern hemisphere, when the control circuit determines that the sun-enter actual time t_{ACT-ENTER} and/or the sun-exit actual time t_{ACT-EXIT} occurred “a little later” or “a lot later”, the control device may be configured to adjust the sun-enter façade limit angle θ_{FL-ENTER} and/or the sun-exit façade limit angle θ_{FL-EXIT}, respectively, by an adjustment amount having a positive value (e.g., approximately 5° or 10°), which may cause the sun-enter façade limit angle θ_{FL-ENTER} to move closer to the façade angle θ_{F} (e.g., the sun-enter event may occur later in time). For the southern hemisphere, when the control circuit determines that the sun-enter actual time t_{ACT-ENTER} and/or the sun-exit actual time t_{ACT-EXIT} occurred “a little earlier” or “a lot earlier”, the control device may be configured to adjust sun-enter façade limit angle θ_{FL-ENTER} and/or the sun-exit façade limit angle θ_{FL-EXIT}, respectively, by an adjustment amount having a positive value (e.g., approximately 5° or 10°), which may cause the sun-enter façade limit angle θ_{FL-ENTER} to move further away from the façade angle θ_{F} (e.g., the sun-enter event may occur earlier in time). In addition, for the southern hemisphere, when the control circuit determines that the sun-enter actual time t_{ACT-ENTER} and/or the sun-exit actual time t_{ACT-EXIT} occurred “a little later” or “a lot later”, the control device may be configured to adjust the sun-enter façade limit angle θ_{FL-ENTER} and/or the sun-exit façade limit angle θ_{FL-EXIT}, respectively, by an adjustment amount having a negative value (e.g., approximately −5° or −10°), which may cause the sun-enter façade limit angle θ_{FL-ENTER} to move closer to the façade angle θ_{F} (e.g., the sun-enter event may occur later in time).

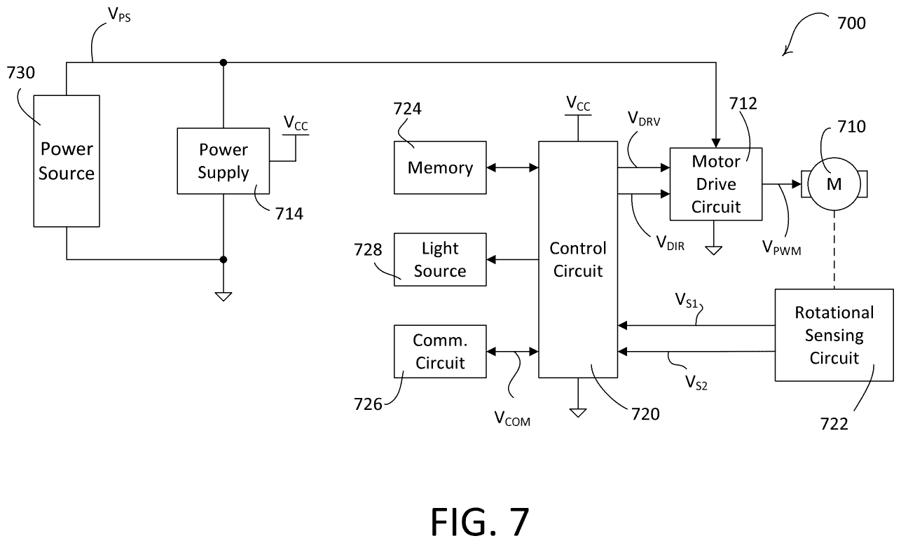

FIG. 7 is a simplified block diagram of a motor drive unit 700 of a motorized window treatment (e.g., the motor drive unit 156 of the motorized window treatments 150, the motor drive unit 166 of the motorized window treatments 160, the motor drive unit 250 of the motorized window treatment 200, and/or the motor drive unit 350 of the motorized window treatment 300). The motor drive unit 700 may include a motor 710 (e.g., a direct-current motor) that may be operated to adjust a covering material (e.g., the flexible material 220 and/or the plurality of slats 320) of the motorized window treatment. For example, the motor 710 may be coupled to a roller tube of the motorized window treatment (e.g., the roller tube 210) for rotating the roller tube to raise and lower the covering material. In addition, the motor 710 may be rotated to control a position of a bottom bar (e.g., the bottom bar 340) and/or a tilt angle of one or more slats (e.g., the slats 320). The motor drive unit 700 may comprise a power source 730 for producing a power source voltage V_{PS}. For example, the power source 730 may comprise one or more batteries and/or a photo-voltaic power source (e.g., a solar cell). In addition, the power source 730 may comprise one or more energy storage elements, such as super capacitors and/or rechargeable batteries. Further, the power source 730 may also be configured to receive power from an external power source, such as an external direct-current (DC) power source or an alternating-current (AC) power source.

The motor drive unit 700 may include a motor drive circuit 712 (e.g., an H-bridge drive circuit) that receives the power source voltage V_{PS} and may generate a pulse-width modulated (PWM) voltage V_{PWM} for driving the motor 810. While not shown in FIG. 7, the motor drive unit 700 may comprise a power converter circuit (e.g., a boost converter circuit) coupled between the power source 730 and the motor drive circuit 712 for receiving the battery voltage V_{BATT} and generating a boosted voltage that may be received by the motor drive circuit 712 for driving the motor 712. The motor drive unit 700 may also include a power supply 714 that may receive the battery voltage V_{BATT} and generate a supply voltage V_{CC} for powering the low-voltage circuitry of the motor drive unit.

The motor drive unit 700 may include a control circuit 820 for controlling the operation of the motor 710. The control circuit 720 may include, for example, a microprocessor, a programmable logic device (PLD), a microcontroller, an application specific integrated circuit (ASIC), a field-programmable gate array (FPGA), or any suitable processing device or control circuit. The control circuit 720 may be configured to generate one or more drive signals V_{DR} for controlling the motor drive circuit 712. The one or more drive signals V_{DR} may be configured to control a rotational speed and/or a direction of rotation of the motor 710.

The motor drive unit 700 may include a rotational position sensing circuit 722, such as, for example, a Hall effect sensor (HES) circuit, which may be configured to generate first and second rotational position sensing signals V_{S1}, V_{S2}. The first and second rotational position sensing signals V_{S1}, V_{S2} may indicate the rotational speed and/or the direction of the motor 710 to the control circuit 720. The rotational position sensing circuit 722 may include other suitable position sensors, such as, for example, magnetic, optical, and/or resistive sensors. The control circuit 720 may be configured to determine the rotational position of the motor 710 in response to the first and second rotational position sensing signals V_{S1}, V_{S2} generated by the rotational position sensing circuit 722. The control circuit 720 may be configured to determine a present position of the covering material in response to the rotational position of the motor 710.

The motor drive unit 700 may comprise a memory 724 that may be communicatively coupled to the control circuit 710 for the storage and/or retrieval of data. The memory 724 may be implemented as an external integrated circuit (IC) or as an internal circuit of the control circuit 710. The memory 724 may comprise a computer-readable storage media or machine-readable storage media that maintains computer-executable instructions for performing one or more procedures and/or functions as described herein. For example, the memory 724 may comprise computer-executable instructions or machine-readable instructions that when executed by the control circuit 710 configure the control circuit 710 to provide one or more portions of the procedures described herein (e.g., determine time clock schedules, access stored time clock schedules, and/or execute commands to move the motorized window treatment according to the time clock schedules). The control circuit 710 may access the instructions from the memory 724 for being executed to cause the control circuit 710 to operate as described herein, or to operate one or more other devices as described herein. The memory 724 may comprise computer-executable instructions for executing configuration software. For example, the control circuit 710 may be configured to store in and retrieve from the memory 724 operational settings for the motor drive unit, such as, association information (e.g., unique identifiers of control devices of the load control system), a present position of the covering material, and/or limits for controlling the present position of the covering material (e.g., a fully-raised position and/or a fully-lowered position), etc. In addition, the control circuit 710 may be configured to store one or more timeclock schedules in the memory 724. Further, the control circuit 710 may be configured to store in the memory 724 configuration data for the motor drive unit 700 (e.g., a façade angle θ_{F}, first and second offset angles θ_{OFF1}, θ_{OFF2}, and/or first and second façade limit angles θ_{FL1}, θ_{FL2}), which may be used, for example, to generate the one or more timeclock schedules. For example, the operational characteristics, configuration data, and/or timeclock schedules stored in the memory 724 may be configured during a configuration procedure of the processing device 700.

The motor drive unit 700 may comprise a communication circuit 726 configured to communicate (e.g., transmit and/or receive) messages (e.g., digital messages). For example, the communication circuit 726 may comprise one or more wired communication circuits and/or wireless communication circuits. The one or more wired communication circuits and/or wireless communication circuits of the communication circuit 726 may be implemented as external integrated circuits (ICs) or as internal circuits of the control circuit 710. For example, the one or more wireless communication circuits of the communication circuit 726 may include for example, one or more a radio-frequency (RF) transceivers coupled to a respective antenna for transmitting and/or receiving RF signals. In addition, the one or more wireless communication circuits of the communication circuit 726 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 726 may be capable of performing communication via the same communication channels or different communication channels. In addition, the communication circuit 726 may be configured to communicate via a control network (e.g., a wired or wireless control communication link) for communicating with the load control devices of the load control system.

The control circuit 720 may be configured to control the motor 710 to control the movement of the covering material in response to a shade movement command received in signals received via the communication circuit 726 from a remote control device (e.g., during a normal operation mode). During a configuration procedure (e.g., an association procedure), the motor drive unit 700 may be associated with the remote control device, such that the motor drive unit 700 may be responsive to the messages transmitted by the remote control device (e.g., via wireless signals). In addition, the motor drive unit 800 may be configured with one or more operational settings (e.g., preset positions between the raised position and the lowered position) during the configuration procedure. The motor drive unit 700 may include a light source 728 (e.g., one or more light-emitting diodes (LEDs)) that may be illuminated by the control circuit 720, for example, to provide feedback to the user of the motorized window treatment (e.g., during the configuration mode to indicate that the motor drive unit 700 is in the configuration mode).

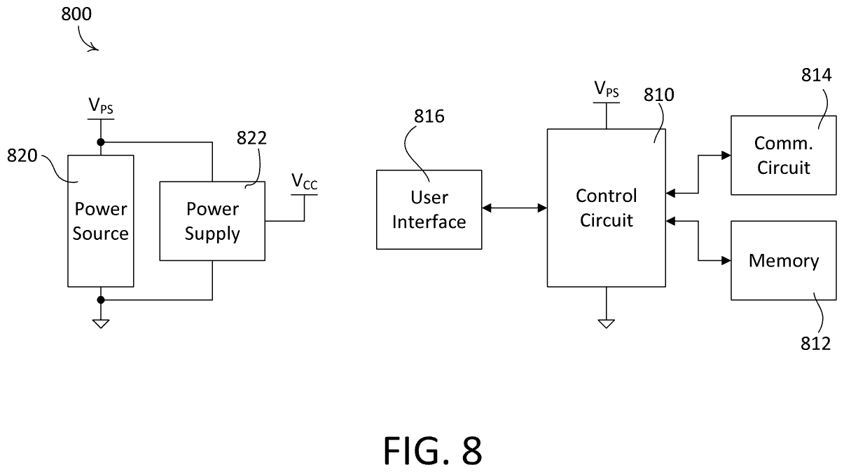

FIG. 8 is a block diagram of an example processing device 800, which may be deployed as the system controller 110, the mobile device 190, a computing device (e.g., a computer and/or a server) running configuration software, and/or another processing device. The control device 800 may comprise a control circuit 810 configured to generate configuration data for configuring the operation of one or more control devices of a load control system (e.g., the load control system 100). In some examples, the control circuit 810 may be configured to generate control data (e.g., commands) for controlling one or more load control devices (e.g., the dimmer switch 120, the LED driver 130, the plug-in load control device 140, the motorized window treatments 150, 160, and/or the thermostat 170). The control circuit 810 may include one or more of a processor (e.g., a microprocessor), a microcontroller, a programmable logic device (PLD), a field programmable gate array (FPGA), an application specific integrated circuit (ASIC), or any suitable controller or processing device.

The processing device 800 may comprise a memory 812 that may be communicatively coupled to the control circuit 810 for the storage and/or retrieval of data. The memory 812 may be implemented as an external integrated circuit (IC) or as an internal circuit of the control circuit 810. The memory 812 may comprise a computer-readable storage media or machine-readable storage media that maintains computer-executable instructions for performing one or more procedure and/or functions as described herein. For example, the memory 812 may comprise computer-executable instructions or machine-readable instructions that when executed by the control circuit 810 configure the control circuit 810 to provide one or more portions of the procedures described herein. The control circuit 810 may access the instructions from the memory 812 for being executed to cause the control circuit 810 to operate as described herein, or to operate one or more other devices as described herein. The memory 812 may comprise computer-executable instructions for executing configuration software. For example, the control circuit 810 may be configured to store in and retrieve from the memory 812 configuration data for configuring the load control devices of the load control system and/or control data for controlling the load control devices of the load control system. In addition, the control circuit 810 may be configured to store in and retrieve from the memory 812 operational settings, such as, association information (e.g., unique identifiers of control devices of the load control system), present intensities levels and/or colors of the lighting loads controlled by the load control devices of the load control system, etc. In addition, the control circuit 810 may be configured to store in the memory 812 one or more timeclock schedules, e.g., to be used for controlling one or more motorized window treatments according to respective shade automation shows. Further, the control circuit 810 may be configured to store in the memory 812 configuration data (e.g., a façade angle θ_{F}, first and second offset angles θ_{OFF1}, θ_{OFF2}, and/or first and second façade limit angles θ_{FL1}, θ_{FL2} of one or more shade groups), which may be used, for example, to generate the one or more timeclock schedules. For example, the operational characteristics, configuration data, and/or timeclock schedules stored in the memory 812 may be configured during a configuration procedure of the processing device 800.

The processing device 800 may comprise a communication circuit 814 configured to communicate (e.g., transmit and/or receive) messages (e.g., digital messages). For example, the communication circuit 814 may comprise one or more wired communication circuits and/or wireless communication circuits. The one or more wired communication circuits and/or wireless communication circuits of the communication circuit 814 may be implemented as external integrated circuits (ICs) or as internal circuits of the control circuit 810. For example, the one or more wireless communication circuits of the communication circuit 814 may include for example, one or more a radio-frequency (RF) transceivers coupled to a respective antenna for transmitting and/or receiving RF signals. In addition, the one or more wireless communication circuits of the communication circuit 814 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 814 may be capable of performing communication via the same communication channels or different communication channels. In some examples, the communication circuit 814 may be configured to communicate via a network, such as a wireless or wired local area network (LAN), e.g., for access to the Internet. In addition, the communication circuit 814 may be configured to communicate via a control network (e.g., a wired or wireless control communication link) for communicating with the load control devices of the load control system. The control circuit 810 may be configured to transmit messages including control data (e.g., one or more commands) for controlling the load control devices via the communication circuit 814. In addition, the control circuit 810 may be configured to receive messages (e.g., including feedback data, such as status information of the load control devices) from the load control devices via the communication circuit 814.

The processing device 800 may further comprise a user interface circuit 816. The user interface circuit 816 may comprise one or more input circuits for receiving inputs. For example, the user interface circuit 816 may comprise one or more actuators configured to be actuated in response to actuation of one or more respective buttons of the processing device 800. In addition, the user interface circuit 816 may comprise a touch sensitive circuit (e.g., a capacitive or resistive touch element) that may be responsive to actuations (e.g., touch actuations) of a touch sensitive surface of the processing device 800 (e.g., a touch screen). Further, the user interface circuit 816 may comprise one or more light sources configured to illuminate visual indicators of the processing device 800 for providing feedback information to a user. In some examples, the user interface circuit 816 may comprise a visual display.

The processing device 800 may comprise a power source 820 for producing a power source voltage V_{PS}. For example, the power source 820 may comprise one or more batteries and/or a photo-voltaic power source (e.g., a solar cell). In addition, the power source 820 may comprise one or more energy storage elements, such as super capacitors and/or rechargeable batteries. Further, the power source 820 may also be configured to receive power from an external power source, such as an external direct-current (DC) power source or an alternating-current (AC) power source. The processing device 800 may also comprise a power supply 822 that may be configured to receive the power source voltage V_{PS} and generate a DC supply voltage V_{CC} for powering the control circuit 810 and other low-voltage circuitry of the processing device 800.

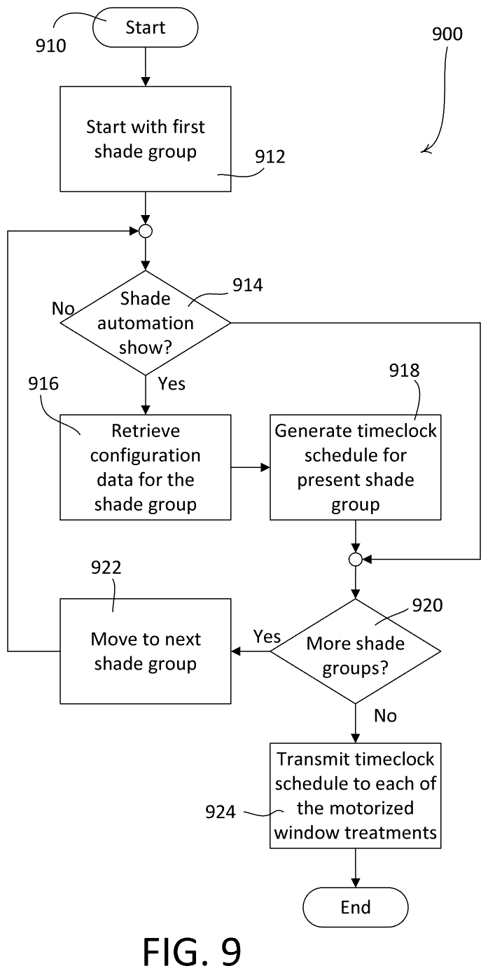

FIG. 9 is a flowchart of an example procedure 900 that may be executed to configure timeclock schedules for controlling (e.g., automatically controlling) one or more motorized window treatments (e.g., the motorized window treatments 150, 160, 200, 300). The procedure 900 may be executed by a control device of a load control system that includes the motorized window treatments (e.g., motorized roller shades and/or motorized blinds). For example, a control circuit of a processing device, such as a system controller (e.g., a control circuit of the system controller 110 and/or the control circuit 810 of the processing device 800) may be configured to execute software and/or firmware based instructions that provide the procedure 900 to generate the timeclock schedules for one of more groups of motorized window treatments (e.g., shade groups), and then either transmit the timeclock schedules to the motorized window treatments of the one or more shade groups or transmit command(s) to the motorized window treatments of the one or more shade groups according to the timeclock schedules. For example, the control circuit may execute the procedure 900 periodically at 910, e.g., once a day to configure timeclock schedules for the motorized window treatments of the one or more shade groups for the coming day.

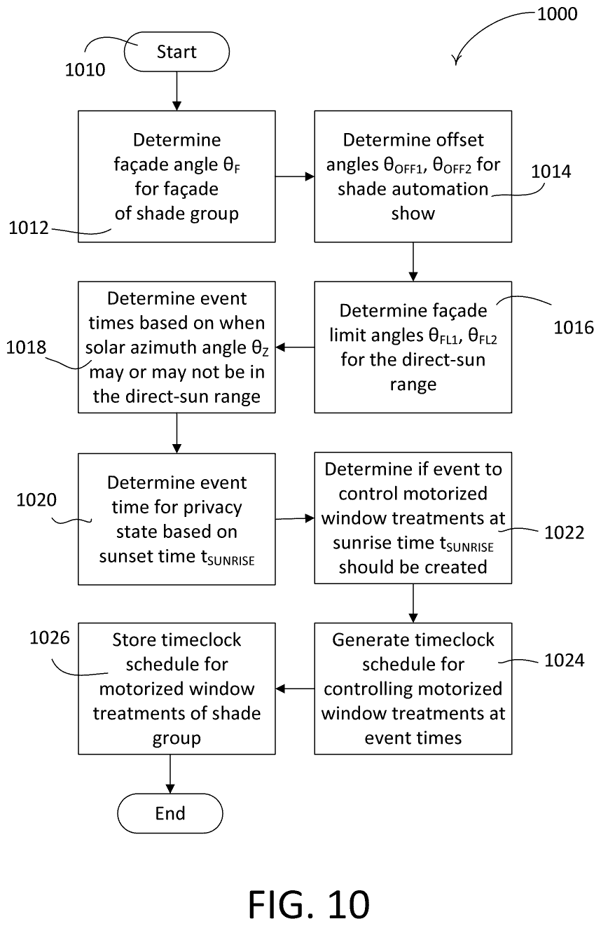

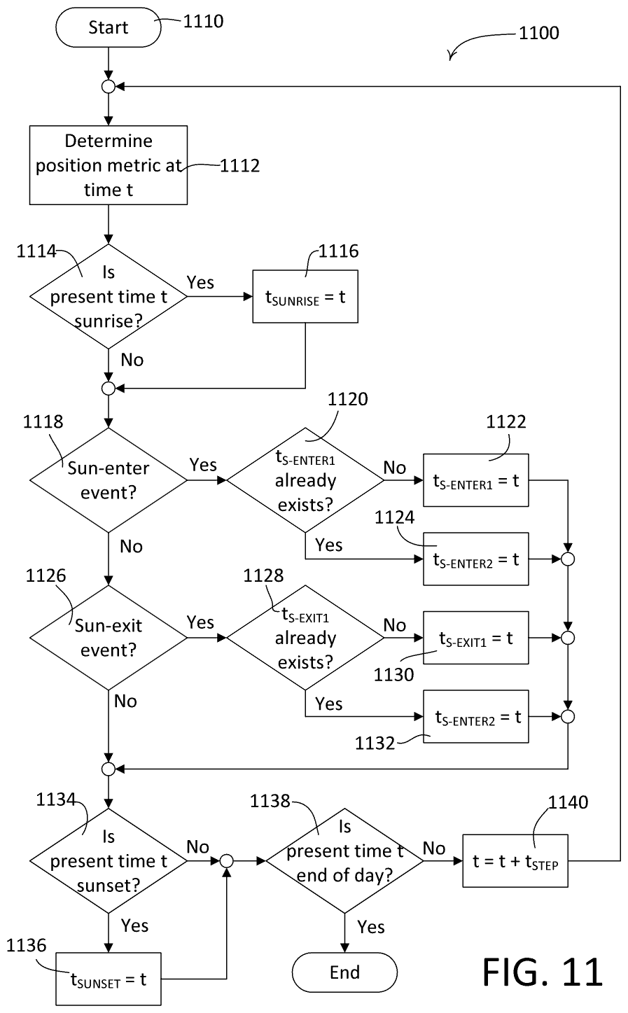

At 912, the control circuit may start with a first shade group of the one or more shade groups for configuring a timeclock schedule for the motorized window treatments of that shade group. If a shade automation show has been configured for that shade group at 914, the control circuit may retrieve configuration data for that shade group (e.g., configuration data for the shade automation show of that shade group) from memory at 916. For example, the control circuit may retrieve from memory a façade angle θ_{F}, first and second offset angles θ_{OFF1}, θ_{OFF2}, and/or first and second façade limit angles θ_{FL1}, θ_{FL2} at 916 (e.g., as determined based on user inputs received via the screen 600). At 918, the control circuit may configure a timeclock schedule for the motorized window treatments of the present shade group according to the configuration data (e.g. as retrieved from memory at 916). For example, the control circuit may set the events of the timeclock schedule to control the state (e.g., to a direct-sun state, a view state, and/or a privacy state) of each of the motorized window treatments of the present shade group, for example, to maximize indirect sunlight entering the space while minimizing direct sunlight entering the space (e.g., as will be described below with reference to FIGS. 10 and 11). In addition, the control circuit may configure the timeclock schedule to control the position of covering material and/or tilt angle of slats of the motorized window treatments according to the state (e.g., to a direct-sun state, a view state, and/or a privacy state) of each of the events of the timeclock schedule (e.g., to the positions and/or tilt angles set by the direct-sun position field 622, the direct-sun tilt angle field 624, the view position field 632, the view tilt angle field 634, the privacy position field 642, and the privacy tilt angle field 644 of the shade automation show configuration area 610 of the screen 600). The control circuit may also be configured to store the timeclock schedule in memory at 918. If a shade automation show has not been configured for that shade group at 914, the control circuit may not configure a timeclock schedule for that shade group.

If there are more shade groups in the load control system at 920, the control device may move to the next shade group at 922. The control circuit may again determine, at 914, if a shade automation show has not been configured for that shade group. If a shade automation show has not been configured for that shade group at 914, the control circuit may retrieve the configuration data for the shade group at 916 and configure a timeclock schedule for that shade group at 918. When there are no more shade groups in the load control system at 920, the control device may transmit (e.g., optionally transmit) the timeclock schedules to each of the respective motorized window treatments (e.g., corresponding to the respective shade group) at 922, before the timeclock schedule configuration procedure 900 exits. The motorized window treatments may each store the respective timeclock schedule and execute respective events of the respective timeclock schedules at the pre-configured times over the coming day. In some examples, rather than transmitting the timeclock schedules to the motorized window treatments at 922, the procedure 900 may end with the timeclock schedules stored in the memory, and the control circuit may subsequently control the motorized window treatments based on the timeclock schedules by communicating commands to the motorized window treatments according to the timeclock schedule at the pre-configured times over the coming day.

FIG. 10 is a flowchart of another example procedure 1000 that may be executed to configure a timeclock schedule for controlling (e.g., automatically controlling) states (e.g., positions of covering materials and/or tilt angles of slat) of one or more motorized window treatments (e.g., the motorized window treatments 150, 160, 200, 300) of a particular shade group and/or on a particular façade of a building in which the motorized window treatments are located. The procedure 1000 may be executed by a control device (e.g., the system controller 150 and/or the motorized window treatments 150, 200, 300) of a load control system that includes the motorized window treatments (e.g., motorized roller shades and/or motorized blinds). For example, a control circuit of a processing device, such as a system controller (e.g., a control circuit of the system controller 110 and/or the control circuit 810 of the processing device 800) may be configured to execute the procedure 1000 to generate the timeclock schedule. In addition, a control circuit of one of the motorized window treatments of the load control system (e.g., the control circuit 720 of the motorized window treatment 700) may be configured to execute the procedure 1000 to generate the timeclock schedule. For example, the control circuit may execute the procedure 1000 periodically at 1010, e.g., once a day to configure timeclock schedules for one or more of the motorized window treatments for the coming day. The procedure 1000 may be executed, for example, at 916 of the procedure 900 shown in FIG. 9.

At 1012, the control circuit may determine a façade angle θ_{F} for the façade on which the motorized window treatments of the shade group are installed. For example, the control circuit may be configured to retrieve the façade angle θ_{F} from system configuration data for the shade group that is stored in memory. At 1014, the control circuit may determine offset angles θ_{OFF1}, θ_{OFF2} for the shade automation show of the shade group (e.g., to be used for setting a direct-sun range of the façade). For example, the control circuit may be configured to retrieve the offset angles θ_{OFF1}, θ_{OFF2} from system configuration data for the shade automation show of the shade group that is stored in memory. At 1016, the control circuit may set the direct-sun range by determining façade limit angles θ_{FL1}, θ_{FL2} for the shade automation show. The control circuit may set the façade limit angles θ_{FL1}, θ_{FL2} based on the façade angle θ_{F} of the façade (e.g., as determined at 1012) and the offset angles θ_{OFF1}, θ_{OFF2} (e.g., as determined at 1014). For example, the control circuit may be configured to determine the first façade limit angle θ_{FL1} by adding the first offset angle θ_{OFF1} to the façade angle θ_{F} (e.g., θ_{FL1}=θ_{F}+θ_{OFF1}) and determine the second façade limit angle θ_{FL2} by adding the second offset angle θ_{OFF2} to the façade angle θ_{F} (e.g., θ_{FL2}=θ_{F}+θ_{OFF2}).

At 1018, the control circuit may determine event times for controlling the motorized window treatments of the shade group to prevent direct sunlight from shining into the space. The control circuit may determine event times (e.g., a sun-enter time t_{S-ENTER} and/or a sun-exit time t_{S-EXIT}) for controlling the motorized window treatment to the direct-sun state and/or out of the direct-sun state (e.g., and into the view state) depending upon the predicted position of the sun throughout the course of the upcoming day. At 1018, the control circuit may determine whether the sun is in a position to shine directly on the façade of the shade group by calculating the solar azimuth angle θ_{Z} of the sun, and then determining if the solar azimuth angle θ_{Z} is between a sun-enter façade limit angle θ_{FL-ENTER} and a sun-exit façade limit angle θ_{FL-EXIT}. The sun-enter façade limit angle θ_{FL-ENTER} may be one of the façade limit angles θ_{FL1}, θ_{FL2} for the shade automation show and the sun-exit façade limit angle θ_{FL-EXIT} may be the other one of the façade limit angles θ_{FL1}, θ_{FL2} for the shade automation show (e.g., depending upon the hemisphere in which the load control system is located). For example, the sun-enter façade limit angle θ_{FL-ENTER} may be the first façade limit angle θ_{FL1} in the northern hemisphere and the second façade limit angle θ_{FL2} in the southern hemisphere, and the sun-exit façade limit angle θ_{FL-EXIT} may be the second façade limit angle θ_{FL2} in the northern hemisphere and the first façade limit angle θ_{FL1} in the southern hemisphere. The control circuit may generate a sun-enter event at a sun-enter time t_{S-ENTER} to cause the motorized window treatment to change to the direct-sun state the solar azimuth angle θ_{Z} enters the direct-sun range (e.g., traverses the sun-enter façade limit angle θ_{FL-ENTER}). In addition, the control circuit may generate a sun-exit event at a sun-exit time t_{S-EXIT} to cause the motorized window treatment to change to the view state the solar azimuth angle θ_{Z} exits the direct-sun range (e.g., traverses the sun-exit façade limit angle θ_{FL-EXIT}). In some examples, the control circuit may be configured to create multiple sun-enter events at multiple sun-enter times t_{S-ENTER} and multiple sun-exit events at multiple sun-exit times t_{S-EXIT} (e.g., when the building is located near the equator).

At 1020, the control device may determine an event time at which the motorized window treatments may be controlled to the privacy state (e.g., a privacy state time t_{PRIV}). The privacy state time t_{PRIV} may be determined based on a sunset time t_{SUNSET} for the upcoming day. For example, the control circuit may set the privacy time t_{PRIV} to be an offset time t_{OFFSET} (e.g., 30 minutes) from the sunset time t_{SUNSET} (e.g., before and/or after the sunset time t_{SUNSET}). At 1022, the control circuit may determine an event time at which the motorized window treatments may be controlled out of the privacy state based on a sunrise time t_{SUNRISE} for the upcoming day. For example, if one of the sun-enter times t_{S-ENTER} is equal to the sunrise time t_{SUNRISE} for façade of the shade group (e.g., the façade of the shade group is facing in an eastward direction and the sun may be in a position to shine directly on the façade at sunrise), the control circuit does not need to create an additional timeclock event at the sunrise time t_{SUNRISE} to cause the motorized window treatments to move from the privacy state (e.g., the motorized window treatments will be controlled to the direct-sun state at the sunrise time t_{SUNRISE}). However, if none of the sun enter times t_{S-ENTER} are equal to the sunrise time t_{SUNRISE} for the façade of the shade group (e.g., the sun may not be in a position to shine directly on the façade of the shade group at sunrise), the control circuit may determine an event time for controlling the motorized window treatments to the view state at the sunrise time t_{SUNRISE}.

At 1024, the control circuit may generate a timeclock schedule for the motorized window treatments of the shade group for the upcoming day for controlling the motorized window treatments to the direct-sun state, the view state, and the privacy state at the determined event times (e.g., as determined at 1018, 1020, and 1022). For example, the control circuit may generate timeclock events for controlling the motorized window treatments to the direct-sun state at one or more sun enter times t_{S-ENTER}, timeclock events for controlling the motorized window treatments to the view state at one or more determined sun exit times t_{S-EXIT}, and/or controlling the motorized window treatments to the privacy state at the privacy time t_{PRIV} (e.g., as shown in FIG. 4D). At 1026, the control circuit may store the timeclock schedule for the motorized window treatments of the shade group (e.g., an individual timeclock schedule), before the procedure 1000 ends. The procedure 1000 may be repeated (e.g., successively repeated) for one or more other shade groups and/or façades of the building that include motorized window treatments. Alternatively, the procedures 1000 for generating the timeclock schedules for the shade groups and/or façades of a building may be performed simultaneously for each of the shade groups and/or façades of the building.

FIG. 11 is a flowchart of an example procedure 1100 that may be executed to configure timeclock events of a timeclock schedule for controlling (e.g., automatically controlling) one or more motorized treatments (e.g., the motorized window treatments 150, 160, 200, 300). The procedure 1100 may be executed by a control device (e.g., the system controller 150 and/or the motorized window treatments 150, 160, 200, 300) of a load control system that includes the motorized window treatments (e.g., motorized roller shades and/or motorized blinds). For example, a control circuit of a processing device, such as a system controller (e.g., a control circuit of the system controller 110 and/or the control circuit 810 of the processing device 800) may be configured to execute the procedure 1100 to generate the timeclock schedule. In addition, a control circuit of one of the motorized window treatments of the load control system (e.g., the control circuit 720 of the motorized window treatment 700) may be configured to execute the procedure 1100 to generate the timeclock schedule. For example, the control circuit may execute the procedure 1100 periodically at 1110, e.g., once a day to configure timeclock schedules for one or more of the motorized window treatments for the coming day. The procedure 1100 may be executed, for example, at 916 of the procedure 900 shown in FIG. 9.

During the procedure 1100, the control circuit may step through each minute of a day and calculate a position metric of the sun (e.g., a solar azimuth angle θ_{Z} of the sun) at each minute to determine if the motorized window treatments should be controlled to the direct-sun state and/or the view state (e.g., in accordance with configuration data stored in memory). At 1112, the control circuit may determine the position metric of the sun (e.g., the solar azimuth angle θ_{Z} of the sun) for the façade of the shade group at a present time t. The present time t may be initialized to zero (e.g., midnight) when the procedure 1100 is started. For example, the control circuit may calculate the solar azimuth angle θ_{Z} at 1112 using the equations 1-6 shown above. The standard time tₛ of the equations 1-6 may be set to the present time t. The control circuit may be configured to calculate the solar azimuth angle θ_{Z} as a function of the longitude λ and the latitude Φ of the building in which the motorized window treatments may be installed.

At 1114, the control circuit may determine if the present time t is at sunrise for the upcoming day. The control circuit may determine that the present time t is at sunrise by calculating a profile angle θ_{P} for a façade angle θ_{F} directed due east (e.g., for a façade angle θ_{F} of −90°). If the profile angle θ_{P} for the façade angle θ_{F} directed due east just became greater than 0° (e.g., indicates that the sun may have just passed the horizon and be in a position to shine directly on the façade), the control circuit may conclude that the present time t is at sunrise. If the present time t is at sunrise at 1114, the control circuit may set a sunrise time t_{SUNRISE} equal to the present time t at 1116.

At 1118, the control circuit may determine that the determined position metric of the sun indicates a sun-enter event at the present time t (e.g., when the sun just moved into a position to shine directly on the façade of the shade group). For example, the control circuit may determine that the sun just moved into a position to shine directly on the façade at the present time t by determining if a calculated solar azimuth angle θ_{Z} at a previous time was outside of the direct-sun range (e.g., between the façade limit angles θ_{FL1}, θ_{FL2}), and a calculated solar azimuth angle θ_{Z} at the present time t is now inside of the range (e.g., between the façade limit angles θ_{FL1}, θ_{FL2}, which may be retrieved from and/or calculated based on the configuration data stored in memory). The previous time may be one minute prior to the present time t. The previous time may be denoted as t−1. If the control circuit determines that the sun just moved into a position to shine directly on the façade of the shade group at the present time t at 1118 and a first sun-enter time t_{S-ENTER1} does not already exist at 1120, the control circuit may set the first sun-enter time t_{S-ENTER1} equal to the present time t at 1122. If the first sun-enter time t_{S-ENTER1} already exists at 1120, the control circuit may set a second sun-enter time t_{S-ENTER2} equal to the present time t at 1124.

If the control circuit determines that the determined position metric of the sun does not indicate a sun-enter event at 1118, the control circuit may determine if the determined position metric of the sun indicates a sun-exit event at the present time t (e.g., when the sun just moved into a position so as to not shine directly on the façade of the shade group) at 1126. For example, the control circuit may determine that the sun just moved into a position so as to no longer shine directly on the present façade at the present time t by determining if a calculated solar azimuth angle θ_{Z} at the previous time was inside of the direct-sun range (e.g., between the façade limit angles θ_{FL1}, θ_{FL2}), and a calculated solar azimuth angle θ_{Z} at the present time t is now outside of the direct-sun range (e.g., between the façade limit angles θ_{FL1}, θ_{FL2}). The control circuit may determine whether a first sun-exit time t_{S-EXIT1} is defined (e.g., already exists). If the control circuit determines that the sun just moved into a position so as to no longer shine directly on the façade at the present time t at 1126 and the first sun-exit time t_{S-EXIT1} does not already exist at 1128, the control circuit may set the first sun-exit time t_{S-EXIT1} equal to the present time t at 1130. If the first sun-exit time t_{S-EXIT1} already exists at 1128, the control circuit may set a second sun-exit time t_{S-EXIT2} equal to the present time t at 1130.

At 1134, the control circuit may determine if the present time t is at sunset for the upcoming day. The control circuit may determine that the present time t is at sunset by calculating a profile angle θ_{P} for a façade angle θ_{F} directed due west (e.g., for an façade angle θ_{F} of 90°). If the profile angle θ_{P} for a façade angle θ_{F} directed due west just became less than 0° (e.g., indicates that the sun may have just passed the horizon and may no longer in a position to shine directly on the façade), the control circuit may conclude that the present time t is at sunset. If the present time t is at sunset at 1134, the control circuit may set a sunrise time t_{SUNSET} equal to the present time t at 1136. If the present time t is not equal to the end of the upcoming day (e.g., midnight) at 1138, the control circuit device may increase the present time t by a step value t_{STEP} (e.g., one minute) at 1140, and the procedure 1100 may loop around to determine the position metric of the sun at the updated present time t at 1112. When the present time t is equal to the end of the upcoming day at 1138, the procedure 1100 may end. The control circuit may be configured to use the times determined in the procedure 1100 to generate events of a timeclock schedule for controlling the motorized window treatments to the direct-sun state, the view state, or the privacy state (e.g., as described herein).

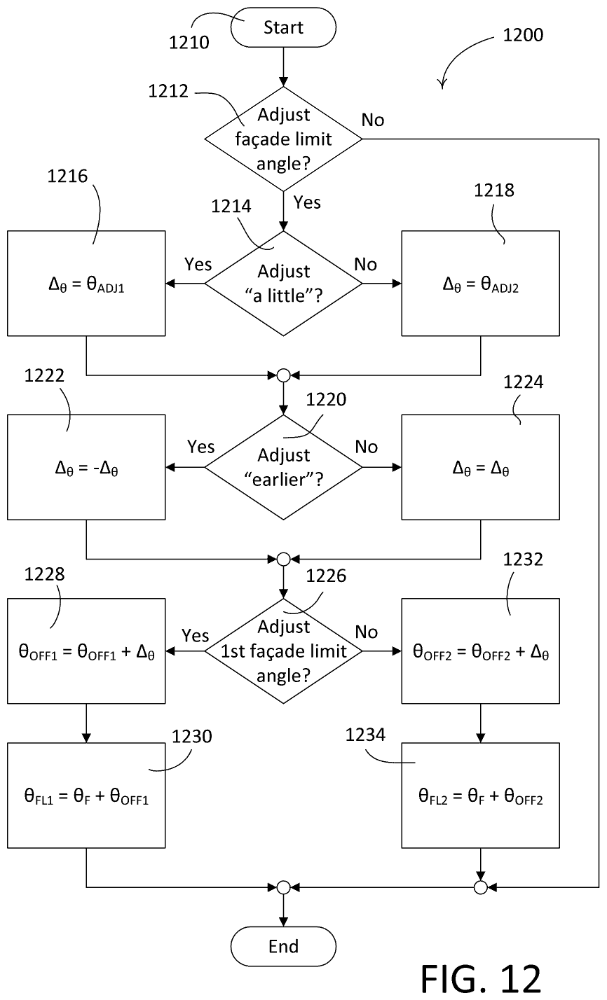

FIG. 12 is a flowchart of an example procedure 1200 that may be executed to configure a direct-sun range of a shade automation show. The procedure 1200 may be executed by a control device (e.g., the system controller 150 and/or the motorized window treatments 150, 160, 200, 300) of a load control system that includes motorized window treatments (e.g., motorized roller shades and/or motorized blinds). For example, a control circuit of a processing device, such as a system controller (e.g., a control circuit of the system controller 110 and/or the control circuit 810 of the processing device 800) may be configured to execute the procedure 1200 to configure the direct-sun range of the shade automation show. In addition, a control circuit of one of the motorized window treatments of the load control system (e.g., a control circuit of one of the motorized window treatments 150, 160, 200, 300 and/or the control circuit 720 of the motorized window treatment 700) may be configured to execute the procedure 1100 to configure the direct-sun range of the shade automation show. The direct-sun range of the shade automation show may be defined by, for example, a first façade limit angle θ_{FL1} and/or a second façade limit angle θ_{FL2}. The first façade limit angle θ_{FL1} and/or a second façade limit angle θ_{FL2} may be used to create in a timeclock schedule one or more sun-enter events (e.g., which each may occur at a corresponding sun-enter time t_{S-ENTER} at which to control the motorized window treatments to the direct-sun state during the upcoming day) and/or one or more sun-exit events (e.g., which each may occur at a corresponding sun-exit time t_{S-EXIT} at which to control the motorized window treatments to the view state during the upcoming day).

The control circuit may execute the procedure 1200, for example, periodically and/or in response to a received user input and/or a received message at 1210. The control circuit may be configured to execute the procedure 1200 to update configuration data stored in memory (e.g., one or more of first and second offset angles θ_{OFF1}, θ_{OFF2} and/or first and second façade limit angles θ_{FL1}, θ_{FL2} of the shade automation show) in response to a user input received, for example, via the screen 600 shown in FIG. 6. In addition, the control circuit may be configured to execute the procedure 1200 multiple times in response to multiple changes received via the sun-enter adjustment list of the sun-enter adjustment field 656 and/or the sun-exit adjustment list of the sun-exit adjustment field 658 of the screen 600.

In some examples, the control circuit may be configured to update (e.g., automatically update) the configuration data stored in the memory (e.g., one or more of first and second offset angles θ_{OFF1}, θ_{OFF2} and/or first and second façade limit angles θ_{FL1}, θ_{FL2} of the shade automation show) in response to a light intensity outside of a building as measured at the façade of the building on which the motorized window treatment is installed. The control circuit may be configured to determine the light intensity outside of a building in response to a sensing circuit configured to measure the light intensity outside of the building at the façade of the building on which the motorized window treatment is installed. For example, the control circuit may be configured to determine the light intensity outside of a building from a window sensor of the load control system (e.g., the window sensor 186), an integral photosensor of one of the motorized window treatments of the load control system (e.g., the photosensor on the motor drive units 156, 166 and/or on the headrail 164) and/or one or more integral solar cells of one of the motorized window treatments of the load control system (e.g., the solar cells located on the bottom bars 155, 165 of the motorized window treatments 150, 160). The control circuit may be configured to determine a sun-enter actual time t_{ACT-ENTER} that direct sunlight began to shine on the façade and/or a sun-exit actual time t_{ACT-EXIT} that direct sunlight stopping shining on the façade in response to the magnitude of the light intensity outside of the building. The control circuit may be configured to determine a difference Δ_{DIFF-ENTER} between the sun-enter actual time t_{ACT-ENTER} and the timeclock sun-enter time t_{S-ENTER} (e.g., Δ_{DIFF-ENTER} t_{ACT-ENTER}−t_{S-ENTER}) and/or a difference Δ_{DIFF-EXIT} between the sun-exit actual time t_{ACT-EXIT} and the timeclock sun-exit time t_{S-EXIT} (e.g., Δ_{DIFF-EXIT}−t_{ACT-EXIT}−t_{S-EXIT}).

At 1212, the control circuit may determine whether to adjust one of the first façade limit angle θ_{FL1} and/or the second façade limit angle θ_{FL2} of the shade automation show. In some examples, the control circuit may determine to adjust one of the first façade limit angle θ_{FL1} and/or the second façade limit angle θ_{FL2} when an input to adjust one of the first façade limit angle θ_{FL1} and/or the second façade limit angle θ_{FL2} of the shade automation show has been received. For example, the control circuit may determine that the input to adjust one of the first façade limit angle θ_{FL1} and/or the second façade limit angle θ_{FL2} of the shade automation show has been received in response to a selection of one of the options of the sun-enter adjustment list of the sun-enter adjustment field 656 or the sun-exit adjustment list of the sun-exit adjustment field 658 of the advanced settings area 650 of the screen 600 other than the “On time” option. In some examples, the control circuit may determine to adjust (e.g., automatically adjust) one of the first façade limit angle θ_{FL1} and/or the second façade limit angle θ_{FL2} when an absolute value of the difference Δ_{DIFF-ENTER} and/or the difference Δ_{DIFF-EXIT} exceeds (e.g., is greater than) a first difference threshold Δ_{TH1}. For example, the first difference threshold Δ_{TH1} may represent an amount of time required for the azimuth angle θ_{Z} of the sun at the façade to change approximately 5°. If to the control circuit determines not to adjust one of the first façade limit angle θ_{FL1} and/or the second façade limit angle θ_{FL2} of the shade automation show at 1212, the procedure 1200 may end. For example, the control circuit may determine not to adjust one of the first façade limit angle θ_{FL1} and/or the second façade limit angle θ_{FL2} when the absolute value of the difference Δ_{DIFF-ENTER} and/or the difference Δ_{DIFF-EXIT} does not exceeds (e.g., is less than) the first difference threshold Δ_{TH1}.

If the control circuit determines to adjust one of the first façade limit angle θ_{FL1} and/or the second façade limit angle θ_{FL2} of the shade automation show at 1212, the control circuit may determine an amount of adjustment for which to adjust the first façade limit angle θ_{FL1} and/or the second façade limit angle θ_{FL2} at 1214. The control circuit may determine whether to adjust the first façade limit angle θ_{FL1} and/or the second façade limit angle 62, for example, by an adjustment of “a little” or “a lot” at 1214. For example, the control circuit may be configured to determine that an input indicates an adjustment of “a little” in response to a selection of the “A little earlier” option or “A little later” option of the sun-enter adjustment list of the sun-enter adjustment field 656 or the sun-exit adjustment list of the sun-exit adjustment field 658, or that the input indicates an adjustment of “a lot” in response to a selection of the “A lot earlier” option or “A lot later” option of the sun-enter adjustment list of the sun-enter adjustment field 656 or the sun-exit adjustment list of the sun-exit adjustment field 658. In some examples, the control circuit may be configured to determine to adjust the first façade limit angle θ_{FL1} and/or the second façade limit angle θ_{FL2} by an adjustment of “a lot” when an absolute value of the difference Δ_{DIFF-ENTER} and/or the difference Δ_{DIFF-EXIT} exceeds (e.g., is greater than) a second difference threshold Δ_{TH2}. In addition, control circuit may be configured to determine to adjust the first façade limit angle θ_{FL1} and/or the second façade limit angle θ_{FL2} by an adjustment of “a little” when the absolute value of the difference Δ_{DIFF-ENTER} and/or the difference Δ_{DIFF-EXIT} does not exceed (e.g., is less than) the second difference threshold Δ_{TH2}. For example, the second difference threshold Δ_{TH2} may represent an amount of time required for the azimuth angle θ_{Z} of the sun at the façade to change approximately 10°. The second difference threshold Δ_{TH2} may be, for example, approximately twice the first difference threshold Δ_{TH1}. When the amount of adjustment is “a little” at 1214, the control circuit may set an adjustment amount Δ_{θ} equal to a first predetermined value θ_{ADJ1} (e.g., such as approximately 5°) at 1216. When the amount of adjustment is not “a little” (e.g., the amount of adjustment is “a lot”) at 1214, the control circuit may set the adjustment amount Δ_{θ} equal to a second predetermined value θ_{ADJ2} (e.g., twice the first predetermined value θ_{ADJ1}, such as approximately 10°) at 1218.

After setting the adjustment amount Δ_{θ} at 1216 or 1218, the control circuit may determine a time direction of adjustment indicated by the input at 1220. The control circuit may determine whether to adjust the first façade limit angle θ_{FL1} and/or the second façade limit angle θ_{FL2}, for example, by a time direction of adjustment of “earlier” or “later” at 1220. For example, the control circuit may be configured to determine that an input indicates a time direction of “earlier” in response to a selection of the “A little earlier” option or “A lot earlier” option of the sun-enter adjustment list of the sun-enter adjustment field 656 or the sun-exit adjustment list of the sun-exit adjustment field 658, or that the input indicates a time direction of “later” in response to a selection of the “A little later” option or “A lot later” option of the sun-enter adjustment list of the sun-enter adjustment field 656 or the sun-exit adjustment list of the sun-exit adjustment field 658. In some examples, the control circuit may be configured to determine to adjust the first façade limit angle θ_{FL1} and/or the second façade limit angle θ_{FL2} by a time direction of adjustment of “earlier” when the difference Δ_{DIFF-ENTER} and/or the difference Δ_{DIFF-EXIT} is negative and by a time direction of adjustment of “later” when the difference Δ_{DIFF-ENTER} and/or the difference Δ_{DIFF-EXIT} is positive. When the time direction of adjustment is “earlier” at 1220, the control circuit may set the adjustment amount Δ_{θ} equal to be negative (e.g., Δ_{θ}=−Δ_{θ}) at 1222. When the time direction of adjustment is not “earlier” (e.g., the time direction of adjustment is “later”) at 1220, the control circuit may set the adjustment amount Δ_{θ} equal to be positive (e.g., Δ_{θ}=Δ_{θ}) at 1224. In some examples, the control circuit may not perform any processing for 1224 (e.g., since the value of the adjustment amount Δ_{θ} is maintained the same at 1224).

After setting the adjustment amount Δ_{θ} to be either negative at 1222 or positive at 1224, the control circuit may determine whether to adjust the first façade limit angle θ_{FL1} or the second façade limit angle θ_{FL2} of the shade automation show at 1226. For example, the control circuit may be configured to determine to adjust the first façade limit angle θ_{FL1} in response to a selection of one of the options of the sun-enter adjustment list of the sun-enter adjustment field 656 or to adjust the second façade limit angle θ_{FL2} in response to a selection of one of options of the sun-exit adjustment list of the sun-exit adjustment field 658. In some examples, the control circuit may be configured to determine to adjust the first façade limit angle θ_{FL1} in response to detecting that the absolute value of the difference Δ_{DIFF-ENTER} is greater than the first difference threshold Δ_{TH1}, and/or to adjust the second façade limit angle θ_{FL2} in response to detecting that the absolute value of the difference Δ_{DIFF-EXIT} is greater than the first difference threshold Δ_{TH1}.

When the control circuit determines to adjust the first façade limit angle θ_{FL1} at 1226, the control circuit may be configured to adjust a first offset angle θ_{OFF1} at 1228 (e.g., which may be set to a default value of −90). For example, the control circuit may be configured to adjust the first offset angle θ_{OFF1} by adding the adjustment amount Δ_{θ} to the first offset angle θ_{OFF1} (e.g., θ_{OFF1}=θ_{OFF1}+Δ_{θ}) at 1228. The control circuit may be configured to use the first offset angle θ_{OFF1} to determine the first façade limit angle θ_{FL1}. For example, the control circuit may be configured to determine the first façade limit angle θ_{FL1} by adding the first offset angle θ_{OFF1} to the façade angle θ_{F} at 1230, before the procedure 1200 ends. In some examples, the control circuit may be configured to end the procedure 1200 after adjusting the first offset angle θ_{OFF1} at 1228 and without determining the first façade limit angle θ_{FL1} at 1230 (e.g., 1230 may be omitted from the procedure 1200), and the control circuit may subsequently calculate the first façade limit angle θ_{FL1} when determining if the solar azimuth angle is within the direct-sun range (e.g., at 1018 of the procedure 1000 shown in FIG. 11 and/or at 1118 or 1126 of the procedure 1100 shown in FIG. 12). In addition, rather than determining the first offset angle θ_{OFF1} at 1228 and determining the first façade limit angle θ_{FL1} at 1230, the control circuit may simply determine the first façade limit angle θ_{FL1} by adding the adding the adjustment amount Δ_{θ} to the first façade limit angle θ_{FL1} (e.g., θ_{FL1}=θ_{FL1}+Δ_{θ}).

When the control circuit does not determine to adjust the first façade limit angle θ_{FL1} (e.g., the control circuit determines to adjust the second façade limit angle θ_{FL2}) at 1226, the control circuit may be configured to adjust a second offset angle θ_{OFF2} (e.g., which may be set to a default value of 90) at 1232. For example, the control circuit may be configured to adjust the second offset angle θ_{OFF2} by adding the adjustment amount Δ_{θ} to the second offset angle θ_{OFF2} (e.g., θ_{OFF2}=θ_{OFF2}+Δ_{θ}) at 1232. The control circuit may be configured to use the second offset angle θ_{OFF2} to determine the second façade limit angle θ_{FL2}. For example, the control circuit may be configured to determine the second façade limit angle θ_{FL2} by adding the second offset angle θ_{OFF2} to the façade angle θ_{F} at 1234, before the procedure 1200 ends. In some examples, the control circuit may be configured to end the procedure 1200 after adjusting the second offset angle θ_{OFF2} at 1232 and without determining the second façade limit angle θ_{FL2} at 1234 (e.g., 1234 may be omitted from the procedure 1200), and the control circuit may subsequently calculate the second façade limit angle θ_{FL2} when determining if the solar azimuth angle is within the direct-sun range (e.g., at 1018 of the procedure 1000 shown in FIG. 11 and/or at 1118 or 1126 of the procedure 1100 shown in FIG. 12). In addition, rather than determining the second offset angle θ_{OFF2} at 1232 and determining the second façade limit angle θ_{FL2} at 1234, the control circuit may simply determine the second façade limit angle θ_{FL2} by adding the adding the adjustment amount Δ_{θ} to the second façade limit angle θ_{FL2} (e.g., θ_{FL2}=θ_{FL2}+Δ_{θ}).

The control circuit may be configured to execute the procedure 1200 when the building in which the motorized window treatments are installed is located in the northern hemisphere. When the building is located in the southern hemisphere, the control circuit may be configured to set the adjustment amount Δ_{θ} to be negative at 1222 when the time direction of adjustment indicated by the input is “later” at 1220, and to be positive at 1224 when the time direction of adjustment indicated by the input is “earlier” at 1220. In addition, when the building is located in the southern hemisphere, the control circuit may be configured to determine at 1226 to adjust the second façade limit angle θ_{FL2} in response to a selection of one of the options of the sun-enter adjustment list of the sun-enter adjustment field 656 or to adjust the first façade limit angle θ_{FL1} in response to a selection of one of options of the sun-exit adjustment list of the sun-exit adjustment field 658.

Although features and elements are described herein in particular combinations, each feature or element can be used alone or in any combination with the other features and elements. The methods described herein may be implemented in a computer program, software, instructions, or firmware stored on one or more non-transitory computer-readable media or other machine-readable media for execution by a computer or machine, or portion thereof. For example, the computer-readable or machine-readable media may be executed by a control circuit, such as a processor. Examples of computer-readable media or machine-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs). The control circuit may access the computer program, software, instructions, or firmware stored on the computer-readable media or machine-readable media for being executed to cause the control circuit to operate as described herein, or to operate one or more devices as described herein.

1. A method of controlling a motorized window treatment installed on a façade of a building, the method comprising:
determining a façade angle of the façade of the building;
determining a direct-sun range for the façade of the building based on the façade angle, the direct-sun range extending from a first façade limit angle to a second façade limit angle;
determining to adjust at least one of the first façade limit angle or the second façade limit angle;
determining an adjustment amount for adjusting the at least one of the first façade limit angle or the second façade limit angle;
determining a time direction for adjusting the at least one of the first façade limit angle or the second façade limit angle;
adjusting the at least one of the first façade limit angle or the second façade limit angle based on the determined adjustment amount and the determined time direction; and
controlling the motorized window treatment to a direct-sun state when a solar azimuth angle of the sun at the building is within the direct-sun range.

2. The method of claim 1, wherein controlling the motorized window treatment to a direct-sun state further comprises:
generating a timeclock schedule having at least one event for controlling the motorized window treatment to the direct-sun state, the at least one event defining at an event time that is based on at least one of the first façade limit angle or the second façade limit angle.

3. The method of claim 2, further comprising:
determining an actual time that either direct sunlight started shining on the façade or direct sunlight stopped shining on the façade;
wherein adjusting the at least one of the first façade limit angle or the second façade limit angle further comprises adjusting the at least one of the first façade limit angle or the second façade limit angle in response to the actual time that either direct sunlight started shining on the façade or direct sunlight stopped shining on the façade.

4. The method of claim 3, further comprising:
comparing the event time of the at least one event and the actual time that either direct sunlight was determined to have started shining on the façade or direct sunlight was determined to have stopped shining on the façade;
wherein adjusting the at least one of the first façade limit angle or the second façade limit angle further comprises adjusting the at least one of the first façade limit angle or the second façade limit angle in response to the comparison of the event time and the actual time.

5. The method of claim 4, wherein comparing the event time and the actual time further comprises determining a difference between the actual time and the event time.

6. The method of claim 5, wherein determining the difference between the actual time and the event time further comprises subtracting the event time from the actual time.

7. The method of claim 6, wherein determining to adjust at least one of the first façade limit angle or the second façade limit angle further comprises determining to adjust at least one of the first façade limit angle or the second façade limit angle when an absolute value of the difference between the actual time and the event time is greater than a first difference threshold.

8. The method of claim 7, wherein determining an adjustment amount for adjusting the at least one of the first façade limit angle or the second façade limit angle further comprises setting the adjustment amount to a first value when the absolute value of the difference between the actual time and the event time is less than a second difference threshold, and to a second value when the absolute value of the difference between the actual time and the event time is greater than the second difference threshold, wherein the second value is greater than the first value.

9. The method of claim 8, wherein determining a time direction for adjusting the at least one of the first façade limit angle or the second façade limit angle further comprises setting the adjustment amount to be negative when the difference between the actual time and the event time is negative, and setting the adjustment amount to be positive when the difference between the actual time and the event time is positive.

10. The method of claim 8, wherein determining a time direction for adjusting the at least one of the first façade limit angle or the second façade limit angle further comprises setting the adjustment amount to be positive when the difference between the actual time and the event time is negative, and setting the adjustment amount to be negative when the difference between the actual time and the event time is positive.

11. The method of claim 1, wherein determining to adjust at least one of the first façade limit angle or the second façade limit angle further comprises receiving an indication to adjust at least one of the first façade limit angle or the second façade limit angle.

12. The method of claim 11, wherein receiving an indication to adjust at least one of the first façade limit angle or the second façade limit angle further comprises:
receiving an indication of a selection of one of a number of options for adjusting the at least one of the first façade limit angle or the second façade limit angle.

13. The method of claim 12, wherein determining an adjustment amount for adjusting the at least one of the first façade limit angle or the second façade limit angle further comprises:
determining the adjustment amount in response to the selected one of the number of options for adjusting the at least one of the first façade limit angle or the second façade limit angle.

14. The method of claim 13, wherein determining a time direction for adjusting the at least one of the first façade limit angle or the second façade limit angle further comprises:
determining the time direction in response to the selected one of the number of options for adjusting the at least one of the first façade limit angle or the second façade limit angle.

15. The method of claim 14, wherein determining the adjustment amount further comprises:
setting the adjustment amount to a first predetermined value when the selected one of the number of options is an “a little” option, and to a second predetermined value when the selected one of the number of options is an “a lot” option.

16. The method of claim 15, wherein determining the time direction further comprises:
setting the adjustment amount to be negative when the selected one of the number of options is an “earlier” option, and to be positive when the selected one of the number of options is a “later” option.

17. The method of claim 1, further comprising:
controlling the motorized window treatment to a view state when the solar azimuth angle of the sun at the building is not within the direct-sun range.

18. The method of claim 17, further comprising:
controlling the motorized window treatment to a privacy state during a night-time period.

19. The method of claim 1, wherein adjusting the at least one of the first façade limit angle or the second façade limit angle based on the determined adjustment amount and the determined time direction further comprises:
adding the adjustment amount to the at least one of the first façade limit angle or the second façade limit angle.

20. The method of claim 1, wherein adjusting the at least one of the first façade limit angle or the second façade limit angle based on the determined adjustment amount and the determined time direction further comprises:
adding the adjustment amount to an offset angle; and
setting the at least one of the first façade limit angle or the second façade limit angle equal to the façade angle plus the offset angle.

21-110. (canceled)
